(19) United States
(12) Patent Application Publication
(10) Pub. No.: US 2025/0274819 A1
(43) Pub. Date: Aug. 28, 2025

(54) APPARATUS AND METHOD FOR HANDLING SECURITY FOR L1 AND L2 TRIGGERED MOBILITY IN NEXT GENERATION WIRELESS SYSTEMS

(71) Applicant: Samsung Electronics Co., Ltd., Suwon-si (KR)

(72) Inventors: June HWANG, Suwon-si (KR); Beomsik BAE, Suwon-si (KR); Jinwoo OCK, Suwon-si (KR); Seungri JIN, Suwon-si (KR)

(21) Appl. No.: 19/058,715

(22) Filed: Feb. 20, 2025

(30) Foreign Application Priority Data
Feb. 23, 2024 (KR) 10-2024-0026620

(51) Int. Cl. H04W 36/00; H04W 12/041; H04W 72/231

(52) U.S. Cl. CPC H04W 36/0055; H04W 12/041; H04W 72/231

(57) ABSTRACT

A fifth generation (5G) or sixth generation (6G) communication system for supporting higher data rates is provided. A method for handling security for LI and L2 triggered mobility is provided. The method performed by a terminal in a wireless communication system includes receiving, from a master node (MN), first information on a layer 1/layer 2 triggered mobility (LTM) configuration for candidate primary secondary cells (PSCells) and second information on a mapping between a counter value list and a cell set identification (ID), wherein an LTM configuration ID for a candidate PSCell is associated with the cell set ID of the candidate PSCell, receiving, from the MN, a medium access control (MAC) control element (CE) for an LTM cell switch, the MAC CE including third information indicating the LTM configuration ID for the candidate PSCell, identifying whether the cell set ID of the candidate PSCell corresponds to a serving cell set ID, based on the first information and the third information, in case that the cell set ID of the candidate PSCell does not correspond to the serving cell set ID, updating a counter value for the serving cell set ID to a counter value for the cell set ID of the candidate PSCell based on the second information, and transmitting, to a candidate secondary node (SN) of the candidate PSCell via the MN, the counter value for the cell set ID of the candidate PSCell.

### CROSS-REFERENCE TO RELATED APPLICATION(S)

This application is based on and claims priority under 35 U.S.C. § 119(a) of a Korean patent application number 10-2024-0026620, filed on Feb. 23, 2024 in the Korean Intellectual Property Office, the disclosure of which is incorporated by reference herein in its entirety.

### BACKGROUND

### 1. Field

The disclosure relates to an operation of a terminal in mobile communication systems. More particularly, the disclosure relates to a technology for handling security for layer 1 (L1) and layer 2 (L2) triggered mobility (LTM) in next generation wireless systems.

### 2. Description of Related Art

Fifth generation (5G) mobile communication technologies define implementation in a wide frequency band to enable a fast transmission rate and new services. Specifically, the 5G mobile communication technology can be implemented in an ultra-high frequency band (‘above 6 GHz’) called millimeter wave (mmWave) such as 28 GHz and 39 GHz as well as in a sub 6 GHz frequency band such as 3.5 gigahertz (3.5 GHz). In addition, in the case of sixth generation (6G) mobile communication technology, which is called systems beyond 5G communication, implementation in a terahertz band (e.g., 95 GHz to 3 THz band) is being considered to achieve a transmission rate that is 50 times faster than the 5G mobile communication technology and an ultra low latency time that is reduced to 1/10.

In the early stages of the 5G mobile communication technology, with the goal of ensuring service support and performance requirements for enhanced mobile broadband (eMBB), ultra-reliable low-latency communications (URLLC), and massive machine-type communications (mMTC), standardization has been made for beamforming and massive multi input multi output (MIMO) for mitigating a path loss of radio waves in a ultra-high frequency band and increase a transmission distance of the radio waves, support for various numerologies for efficient utilization of ultra-high frequency resources (operation of multiple subcarrier intervals, etc.) and dynamic operation of slot formats, initial access technology for supporting multi-beam transmission and broadband, definition and operation of a band-wide part (BWP), new channel coding methods, such as a low density parity check (LDPC) code for large-scale data transmission and a polar code for high reliable transmission of control information, L2 pre-processing, network slicing providing a dedicated network specialized for a specific service, etc.

Currently, discussions are underway for improvement and performance enhancement of the initial 5G mobile communication technology in consideration of services that the 5G mobile communication technology is intended to support, and physical layer standardization is in progress for technologies such as vehicle-to-everything (V2X) to help autonomous vehicles determine their driving based on their own locations and status information that the autonomous vehicles transmit and to increase user convenience, new radio unlicensed (NR-U) for system operation that meets various regulatory requirements in an unlicensed band, NR terminal low power consumption technology (user equipment (UE) power saving), a non-terrestrial network (NTN) that is terminal-satellite direct communication to secure coverage in areas where communication with a terrestrial network is impossible, and positioning.

In addition, standardization of wireless interface architecture/protocol fields is in progress for technologies such as industrial Internet of Things (IIoT) for supporting new services through linkage and convergence with other industries, integrated access and backhaul (IAB) that integrates and supports wireless backhaul links and access links to provide nodes for expanding network service areas, mobility enhancement including conditional handover and dual active protocol stack (DAPS) handover, and 2-step Random Access Channel (RACH) for NR that simplifies random access procedures, and standardization of system architecture/service fields is also in progress for 5G baseline architecture (e.g., service based architecture, and service based interface) for combining network functions virtualization (NFV), software-defined networking (SDN) technology, mobile edge computing (MEC) that receives services based on a location of a terminal, etc.

When such 5G wireless systems are commercialized, an explosive increase in connected devices will be connected to a communication network, so, it is expected that the enhanced functions and performance of the 5G wireless systems and the integrated operation of the connected devices will be required. To this end, new research is expected to be conducted on extended reality (XR) to efficiently support augmented reality (AR), virtual reality (VR), and mixed reality (MR), etc., improvement in 5G performance and reduction in complexity using artificial intelligence (AI) and machine learning (ML), AI service support, metaverse service support, drone communications, etc.

In addition, the development of these 5G wireless systems may serve as a basis for the development of not only multi-antenna transmission technology such as new waveform, full dimensional MIMO (FD-MIMO), array antenna, and large scale antenna to ensure coverage in the terahertz band of 6G mobile communication technology, high-dimensional spatial multiplexing technology using metamaterial-based lenses and antennas and orbital angular momentum (OAM) to improve the coverage of terahertz band signals, and reconfigurable intelligent surface (RIS) technology, but also full duplex technology for enhancing frequency efficiency and improving a system network of 6G mobile communication technology, AI-based communication technology that utilizes satellite and artificial intelligence (AI) from the design stage and incorporates end-to-end AI support functions to realize system optimization, and next generation distributed computing technology that realizes services with complexity that exceeds the limits of terminal computing capabilities by utilizing ultra-high-performance communication and computing resources, etc.

With the above description and the development of the wireless systems, various services may be provided. Therefore, methods for providing these services effectively are required.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to handle security deficiencies or security-related issues that may occur when indicating movement of a secondary cell in a dual connection state through a Layer 1 signal or a Layer 2 signal, in relation to supporting movement of a terminal.

Additional aspects will be set forth in part in the description which follows and, in part, will be apparent from the description, or may be learned by practice of the presented embodiments.

In an accordance with an aspect of the disclosure, a method performed by a terminal in a wireless communication system is provided. The method includes receiving, from a master node (MN), first information on a layer 1/layer 2 triggered mobility (LTM) configuration for candidate primary secondary cells (PSCells) and second information on a mapping between a counter value list and a cell set identification (ID), wherein an LTM configuration ID for a candidate PSCell is associated with a cell set ID of the candidate PSCell, receiving, from the MN, a medium access control (MAC) control element (CE) for an LTM cell switch, the MAC CE including third information indicating the LTM configuration ID for the candidate PSCell, identifying whether the cell set ID of the candidate PSCell corresponds to a serving cell set ID, based on the first information and the third information, in case that the cell set ID of the candidate PSCell does not correspond to the serving cell set ID, updating a counter value for the serving cell set ID to a counter value for the cell set ID of the candidate PSCell based on the second information, and transmitting, to a candidate secondary node (SN) of the candidate PSCell via the MN, the counter value for the cell set ID of the candidate PSCell.

In an accordance with another aspect of the disclosure, a method performed by a master node (MN) in a wireless communication system is provided. The method includes transmitting, to a terminal, first information on a layer 1/layer 2 triggered mobility (LTM) configuration for candidate primary secondary cells (PSCells) and second information on a mapping between a counter value list and a cell set identification (ID), wherein an LTM configuration ID for a candidate PSCell is associated with a cell set ID of the candidate PSCell, transmitting, to the terminal, a medium access control (MAC) control element (CE) for an LTM cell switch, the MAC CE including third information indicating the LTM configuration ID for the candidate PSCell, in case that the cell set ID of the candidate PSCell does not correspond to a serving cell set ID, receiving, from the terminal, a counter value for the cell set ID of the candidate PSCell, wherein the serving cell set ID is associated with a PSCell of a secondary node (SN), and the SN is connected with the terminal for a dual connectivity (DC), and transmitting, to a candidate SN of the candidate PSCell, the counter value for the cell set ID of the candidate PSCell.

In an accordance with another aspect of the disclosure, a terminal in a wireless communication system is provided. The terminal includes a transceiver, and a processor coupled with the transceiver and configured to receive, from a master node (MN), first information on a layer 1/layer 2 triggered mobility (LTM) configuration for candidate primary secondary cells (PSCells) and second information on a mapping between a counter value list and a cell set identification (ID), wherein an LTM configuration ID for a candidate PSCell is associated with a cell set ID of the candidate PSCell, receive, from the MN, a medium access control (MAC) control element (CE) for an LTM cell switch, the MAC CE including third information indicating the LTM configuration ID for the candidate PSCell, identify whether the cell set ID of the candidate PSCell corresponds to a serving cell set ID, based on the first information and the third information, in case that the cell set ID of the candidate PSCell does not correspond to the serving cell set ID, update a counter value for the serving cell set ID to a counter value for the cell set ID of the candidate PSCell based on the second information, and transmit, to a candidate secondary node (SN) of the candidate PSCell via the MN, the counter value for the cell set ID of the candidate PSCell.

In an accordance with another aspect of the disclosure, a master node (MN) in a wireless communication system is provided. The MN includes a transceiver, and a processor coupled with the transceiver and configured to transmit, to a terminal, first information on a layer 1/layer 2 triggered mobility (LTM) configuration for candidate primary secondary cells (PSCells) and second information on a mapping between a counter value list and a cell set identification (ID), wherein an LTM configuration ID for a candidate PSCell is associated with a cell set ID of the candidate PSCell, transmit, to the terminal, a medium access control (MAC) control element (CE) for an LTM cell switch, the MAC CE including third information indicating the LTM configuration ID for the candidate PSCell, in case that the cell set ID of the candidate PSCell does not correspond to the serving cell set ID, receive, from the terminal, a counter value for the cell set ID of the candidate PSCell, wherein the serving cell set ID is associated with a PSCell of a secondary node (SN), and the SN is connected with the terminal for a dual connectivity (DC), and transmit, to a candidate SN of the candidate PSCell, the counter value for the cell set ID of the candidate PSCell.

According to an embodiment of the disclosure, it is possible to handle the security issues when any terminal moves to another cell through Layer 1 and/or Layer 2 signals.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of a long term evolution (LTE) system according to an embodiment of the disclosure;

FIG. 2 is a diagram illustrating a wireless protocol structure of an LTE system according to an embodiment of the disclosure;

FIG. 3 is a diagram illustrating a structure of a next generation mobile communication system according to an embodiment of the disclosure;

FIG. 4 is a diagram illustrating a wireless protocol structure of a next generation mobile communication system according to an embodiment of the disclosure;

FIG. 5 is a block diagram illustrating an internal structure of a terminal according to an embodiment of the disclosure;

FIG. 6 is a block diagram illustrating a configuration of an NR base station according to an embodiment of the disclosure;

FIG. 7A is a diagram for describing an inter CU LTM operation according to an embodiment of the disclosure;

FIG. 7B is a diagram for describing an inter CU LTM operation according to an embodiment of the disclosure;

FIG. 7C is a diagram for describing an inter CU LTM operation according to an embodiment of the disclosure;

FIG. 7D is a diagram for describing an inter CU LTM operation according to an embodiment of the disclosure;

FIG. 8 is a diagram for entire opt 1 according to an embodiment of the disclosure;

FIG. 9A is a diagram for describing opt 1 according to an embodiment of the disclosure in relation to an inter CU SCG LTM signal transmission process according to an embodiment of the disclosure;

FIG. 9B is a diagram for describing opt 1 according to an embodiment of the disclosure in relation to an inter CU SCG LTM signal transmission process according to an embodiment of the disclosure;

FIG. 9C is a diagram for describing opt 1 according to an embodiment of the disclosure in relation to an inter CU SCG LTM signal transmission process according to an embodiment of the disclosure;

FIG. 9D is a diagram for describing opt 1 according to an embodiment of the disclosure in relation to an inter CU SCG LTM signal transmission process according to an embodiment of the disclosure;

FIG. 10A is a diagram for describing opt 2 according to an embodiment of the disclosure in relation to an inter CU SCG LTM signal transmission process according to an embodiment of the disclosure;

FIG. 10B is a diagram for describing opt 2 according to an embodiment of the disclosure in relation to an inter CU SCG LTM signal transmission process according to an embodiment of the disclosure; and

FIG. 10C is a diagram for describing opt 2 according to an embodiment of the disclosure in relation to an inter CU SCG LTM signal transmission process according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, some components in the accompanying drawings are exaggerated, omitted, or schematically illustrated. In addition, the size of each component does not entirely reflect the actual size.

Various advantages and features of the disclosure and methods accomplishing the same will become apparent from the following detailed description of embodiments with reference to the accompanying drawings. However, the disclosure is not limited to various embodiments to be described below, but may be implemented in various different forms, the present embodiments will be provided only in order to make the disclosure complete and allow those skilled in the art to completely recognize the scope of the disclosure, and the disclosure will be defined by the scope of the claims. Throughout the disclosure, the same components will be denoted by the same reference numerals.

Specific terms used in the following description are provided to aid understanding of the disclosure, and the use of these specific terms may be changed to other forms within the scope of the technical spirit of the disclosure.

In the following description, terms for identifying access nodes, terms referring to network entities, terms referring to messages, terms referring to interfaces between network entities, terms referring to various types of identification information, etc., are provided for the convenience of description. Accordingly, the disclosure is not limited to terms described below, and other terms referring to objects having equivalent technical meanings may be used.

Hereinafter, a base station is an entity that performs resource allocation of a terminal, and may be at least one of a gNode B, an eNode B, a Node B, a base station (BS), a wireless access unit, a base station controller, or a node on a network. The terminal may include user equipment (UE), a mobile station (MS), a cellular phone, a smartphone, a computer, or a multimedia system capable of performing a communication function. In the disclosure, downlink (DL) refers to a wireless transmission path of a signal that the base station transmits to the UE, and uplink (UL) refers to a wireless transmission path of a signal that the UE transmits to the base station. In addition, although the LTE or LTE-A system may be described as an example below, the embodiments of the disclosure may be applied to other communication systems having similar technical backgrounds or channel types. For example, the 5G generation mobile communication technology (5G, new radio (NR)) developed after the LTE-A may be included in a system to which the embodiments of the disclosure may be applied, and the 5G below may be a concept that includes the existing LTE, LTE-A, and other similar services. In addition, the disclosure may be applied to other communication systems through some modifications without significantly departing from the scope of the disclosure as determined by a person having skilled technical knowledge. In this case, it will be appreciated that each block of a processing flowchart and combinations of the flowcharts may be executed by computer program instructions.

Since these computer program instructions may be mounted in a processor of a general computer, a special computer, or other programmable data processing apparatuses, these computer program instructions executed through the process of the computer or the other programmable data processing apparatuses create means performing functions described in a block(s) of the flow chart. Since these computer program instructions may also be stored in a computer usable or computer readable memory of a computer or other programmable data processing apparatuses in order to implement the functions in a specific scheme, the computer program instructions stored in the computer usable or computer readable memory can also produce manufacturing articles including instruction means performing the functions described in the block(s) of the flowchart. Since the computer program instructions may also be mounted on the computer or the other programmable data processing apparatuses, the instructions performing a series of operation steps on the computer or the other programmable data processing apparatuses to create processes executed by the computer, thereby executing the computer or the other programmable data processing apparatuses may also provide steps for performing the functions described in a block(s) of the flowchart.

In addition, each block may indicate some of modules, segments, or codes including one or more executable instructions for executing a specific logical function(s). Further, it is to be noted that functions mentioned in the blocks occur regardless of an order in some alternative embodiments. For example, two blocks that are continuously illustrated may be simultaneously performed in fact or be performed in a reverse order depending on corresponding functions. The term ‘˜unit’ used in the present embodiment refers to software or a hardware component such as a field programmable gate array (FPGA) or an application specific integrated circuit (ASIC), and ‘˜unit’ play certain roles. However, ‘˜unit’ is not limited to the software or the hardware. The ‘˜unit’ may be configured to be stored in a storage medium that can be addressed or may be configured to regenerate one or more processors. Accordingly, as an example, the ‘˜unit’ refers to components such as software components, object-oriented software components, class components, and task components, processes, functions, attributes, procedures, subroutines, segments of program code, drivers, firmware, microcode, circuits, data, databases, data structures, tables, arrays and variables. Components and functions provided within ‘˜unit’ may be combined into a smaller number of components and ‘˜unit’ or may be further separated into additional components and ‘˜unit’. In addition, components and ‘˜units’ may be implemented to reproduce one or more central processing units (CPUs) in a device or a security multimedia card. In addition, in embodiments, the ‘˜unit’ may include one or more processors.

For the convenience of the following description, the disclosure uses terms and names defined in the 5GS and NR standards, which are standards defined by the 3rd Generation Partnership Project (3GPP) among the existing communication standards. However, the disclosure is not limited to the above terms and names, and may be equally applied to wireless communication networks that follow other standards. For example, the disclosure may be applied to 3GPP 5GS/NR (5G mobile communication standard).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

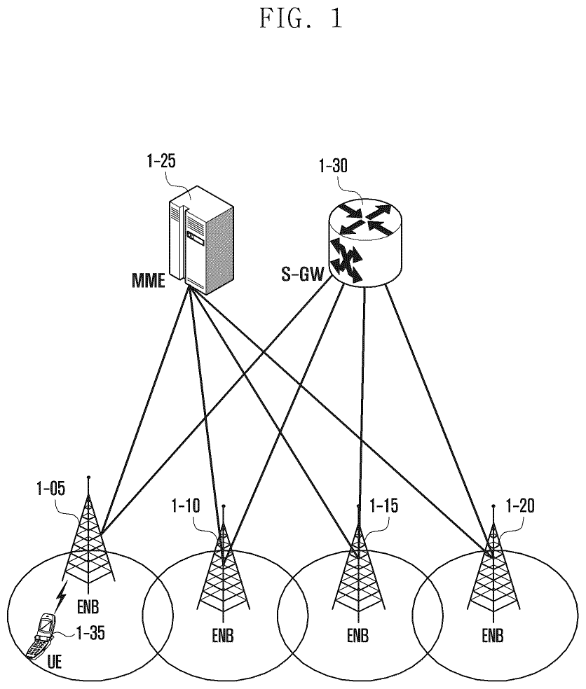

FIG. 1 is a diagram illustrating a structure of an LTE system according to an embodiment of the disclosure.

Referring to FIG. 1, as illustrated, the wireless access network of the LTE system may be composed of next generation base stations (Evolved Node B, hereinafter referred to as ENB, eNB, Node B or base station) 1-05, 1-10, 1-15, and 1-20, a mobility management entity (MME) 1-25, and a serving-gateway (S-GW) 1-30. User UE (hereinafter referred to as user equipment (UE) or terminal (UE)) 1-35 may access an external network through the ENB 1-05 to 1-20 and the S-GW 1-30.

Referring to FIG. 1, the ENBs 1-05 to 1-20 may correspond to the existing Node B of a UMTS system. The ENB is connected to the UE 1-35 through a wireless channel and may perform a more complex role than the existing Node B. In the LTE system, all user traffic including real-time services such as Voice over IP (VOIP) through Internet protocol may be served through a shared channel. Therefore, an entity that collects status information such as a buffer status, an available transmission power status, and a channel status of UEs and performs scheduling is required, and the scheduling may be handled by the ENBs 1-05 to 1-20. One ENB may usually control a plurality of cells. For example, in order to implement a transmission rate of 100 Mbps, the LTE system may use, for example, orthogonal frequency division multiplexing (OFDM) as a wireless access technology in a 20 MHz bandwidth. In addition, the LTE system may apply an adaptive modulation & coding (AMC) method that determines a modulation scheme and a channel coding rate according to a channel status of the UE 1-35. The S-GW 1-30 is an entity that provides a data bearer and may generate or remove the data bearer under the control of the MME 1-25. The MME 1-25 is an entity that is in charge of various control functions as well as mobility management functions for the UE 1-35 and may be connected to the plurality of ENBs 1-05 to 1-20.

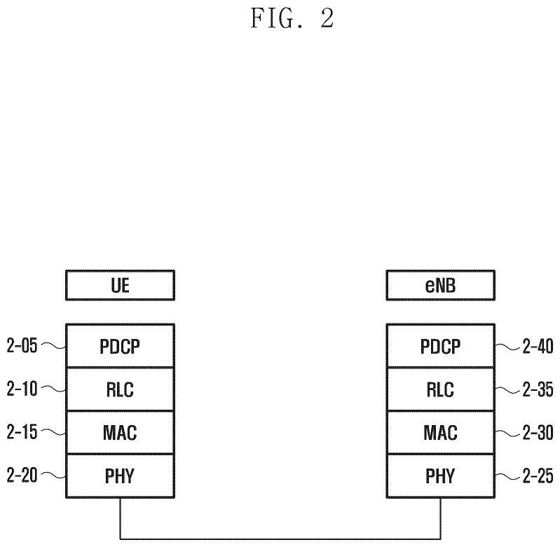

FIG. 2 is a diagram illustrating a wireless protocol structure of an LTE system according to an embodiment of the disclosure.

Referring to FIG. 2, the wireless protocol of the LTE system may be composed of packet data convergence protocols (PDCPs) 2-05 and 2-40, radio link control (RLC) 2-10 and 2-35, and medium access control (MAC) 2-15 and 2-30 in the UE and the ENB, respectively. The PDCPs 2-05 and 2-40 may be in charge of operations such as IP header compression/reconstruction. The main functions of the PDCPs 2-05 and 2-40 may be summarized as follows.
Header compression and decompression function (Header compression and decompression: ROHC only)
User data transfer function (Transfer of user data)
In-sequence delivery function (In-sequence delivery of upper layer PDUs at PDCP re-establishment procedure for the RLC AM)
Reordering function (For split bearers in DC (only support for the RLC AM): the PDCP PDU routing for transmission and the PDCP PDU reordering for reception)
Duplicate detection function (Duplicate detection of lower layer SDUs at PDCP re-establishment procedure for the RLC AM)
Retransmission function (Retransmission of PDCP SDUs at handover and, for split bearers in DC, of PDCP PDUs at the PDCP data-recovery procedure, for the RLC AM)
Ciphering and deciphering function (Ciphering and deciphering)
Timer-based SDU discard function (Timer-based SDU discard in uplink)

The radio link control (RLC) 2-10 and 2-35 may reconfigure a PDCP packet data unit (PDU) to an appropriate size to perform an ARQ operation, etc. The main functions of the RLC may be summarized as follows.
Data transfer function (Transfer of upper layer PDUs)
ARQ function (Error Correction through ARQ (only for AM data transfer))
Concatenation, segmentation, and reassembly function (Concatenation, segmentation and reassembly of the RLC SDUs (only for UM and AM data transfer))
Re-segmentation function (Re-segmentation of RLC data PDUs (only for AM data transfer))
Reordering function (Reordering of the RLC data PDUs (only for UM and AM data transfer))
Duplicate detection function (Duplicate detection (only for UM and AM data transfer))
Error detection function (Protocol error detection (only for AM data transfer))
RLC SDU discard function (RLC SDU discard (only for UM and AM data transfer))
RLC re-establishment function (RLC re-establishment)

The MACs 2-15 and 2-30 are connected to a plurality of RLC layer entities configured in one UE and may perform operations of multiplexing RLC PDUs into a MAC PDU and demultiplexing the RLC PDUs from the MAC PDU. The main functions of the MAC may be summarized as follows.
Mapping function (Mapping between logical channels and transport channels)
Multiplexing and demultiplexing function (Multiplexing/demultiplexing of MAC SDUs belonging to one or different logical channels into/from transport blocks (TB) delivered to/from the physical layer on transport channels)
Scheduling information reporting function (Scheduling information reporting)
HARQ function (Error correction through HARQ)
Priority handling function between logical channels (Priority handling between logical channels of one UE)
Priority handling function between UEs (Priority handling between UEs by means of dynamic scheduling)
MBMS service identification function (MBMS service identification)
Transport format selection function (Transport format selection)
Padding function (Padding)

The physical layers 2-20 and 2-25 may perform an operation of channel coding and modulating higher layer data, converting the higher layer data into OFDM symbols and transmitting the OFDM symbols through a wireless channel, or demodulating and channel decoding the OFDM symbols received through the wireless channel, and delivering the OFDM symbols to a higher layer.

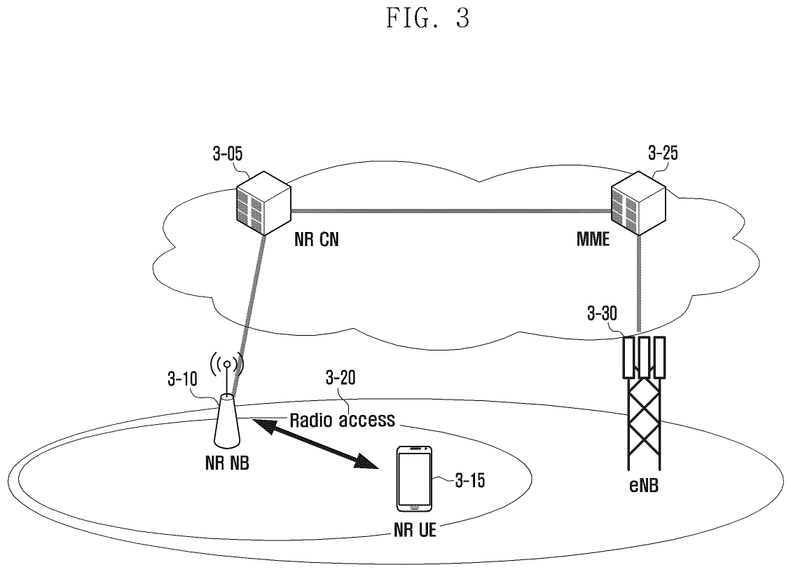

FIG. 3 is a diagram illustrating a structure of a next generation mobile communication system according to an embodiment of the disclosure.

Referring to FIG. 3, a wireless access network of the next generation wireless system (hereinafter referred to as NR or 5 g) may be composed of a next generation base station (New Radio Node B, hereinafter referred to as NR gNB or NR base station) 3-10 and a next generation wireless core network (New Radio Core Network (NR CN)) 3-05. A next generation wireless user UE (New Radio User Equipment (NR UE) or UE) 3-15 may access an external network through the NR gNB 3-10 and the NR CN 3-05.

Referring to FIG. 3, the NR gNB 3-10 may correspond to the Evolved Node B (eNB) of the existing LTE system. The NR gNB is connected to the NR UE 3-15 through a wireless channel and may provide a service that is superior to the existing Node B. In the next generation wireless system, all user traffic may be served through a shared channel. Therefore, an entity that collects status information such as a buffer status, an available transmission power status, and a channel status of UEs and performs scheduling is required, and the scheduling may be handled by the NR NB 3-10. One NR gNB 3-10 may control a plurality of cells. In the next generation wireless system, in order to implement ultra-high-speed data transmission compared to the general LTE, a bandwidth greater than the general maximum bandwidth may be applied. In addition, in the next generation wireless system, the orthogonal frequency division multiplexing (OFDM) may be used as radio access technology and may additionally be combined with beamforming technology. In addition, the adaptive modulation & coding (hereinafter, referred to as AMC) scheme that determines the modulation scheme and the channel coding rate according to the channel status of the UE may be applied. The NR CN 3-05 may perform functions such as mobility support, bearer configuration, and QoS configuration. The NR CN may be connected a plurality of base stations that are in charge of various control functions as well as mobility management functions for the UE. In addition, the next generation wireless system may be linked to the LTE system, and the NR CN 3-05 may be connected to the MME 3-25 through the network interface. The MME 3-25 may be connected to an eNB 3-30, which is an LTE base station.

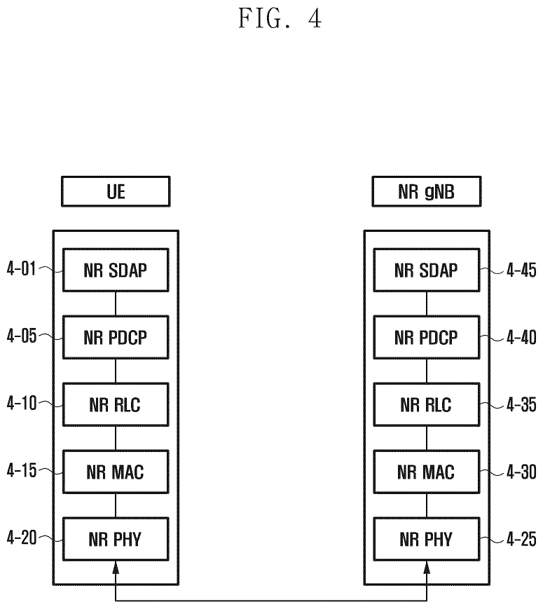

FIG. 4 is a diagram illustrating a wireless protocol structure of the next generation mobile communication system according to an embodiment of the disclosure.

Referring to FIG. 4, the wireless protocol of the next generation wireless system may be composed of NR service data adaptation protocols (SDAPs) 4-01 and 4-45, NR PDCPs 4-05 and 4-40, NR RLC 4-10 and 4-35, NR MAC 4-15 and 4-30, and NR PHYs 4-20 and 4-25 in the UE and the NR base station, respectively.

The main functions of the NR SDAP 4-01 and 4-45 may include some of the following functions.
User data transfer function (Transfer of user plane data)
Mapping function between QoS flow and data bearers for both uplink and downlink (mapping between a QoS flow and a DRB for both DL and UL)
Marking function QoS flow ID in both uplink and downlink (marking QoS flow ID in both DL and UL packets)
Function of mapping reflective QoS flow to data bearers for uplink SDAP PDUs (reflective QoS flow to DRB mapping for the UL SDAP PDUs)

For an SDAP layer entity, the UE may be configured with whether to use a header of the SDAP layer entity or whether to use a function of the SDAP layer entity for each PDCP layer entity, for each bearer, or for each logical channel through a radio resource control (RRC) message. When the SDAP header is configured, the UE may indicate an update or reconfiguration of mapping information for the QoS flow and the data bearer of the uplink and downlink using a non-access stratum (NAS) quality of service (QOS) reflective configuration 1 bit indicator (NAS reflective QoS) of the SDAP header and an access stratum (AS) QoS reflective configuration 1 bit indicator (AS reflective QoS) of the SDAP header. The SDAP header may include QoS flow ID information indicating the QoS. The QoS information may be used as data processing priority, scheduling information, etc., to support seamless services.

The main functions of the NR PDCP 4-05 and 4-40 may include some of the following functions.
Header compression and decompression function (Header compression and decompression: ROHC only)
User data transfer function (Transfer of user data)
In-sequence delivery function (In-sequence delivery of upper layer PDUs)
Out-of-sequence delivery function (Out-of-sequence delivery of upper layer PDUs)
Reordering function (PDCP PDU reordering for reception)
Duplicate detection function (Duplicate detection of lower layer SDUs)
Retransmission function (Retransmission of PDCP SDUs)
Ciphering and deciphering function (Ciphering and deciphering)
Timer-based SDU discard function (Timer-based SDU discard in uplink)

In the above description, the reordering function of the NR PDCP entity may mean a function of reordering the PDCP PDUs received from the lower layer in order based on a PDCP sequence number (PDCP SN). The reordering function of the NR PDCP entity may include a function of delivering data to the higher layer in the reordered order, or include a function of delivering data directly without considering the order, include a function of recording lost PDCP PDUs by reordering the order, include a function of reporting a status of the lost PDCP PDUs to a transmitting side, and include a function of requesting a retransmission of the lost PDCP PDUs.

The main functions of the NR RLC 4-10 and 4-35 may include some of the following functions.
Data transfer function (Transfer of upper layer PDUs)
In-sequence delivery function (In-sequence delivery of upper layer PDUs)
Out-of-sequence delivery function (Out-of-sequence delivery of upper layer PDUs)
ARQ function (Error correction through ARQ)
Concatenation, segmentation, and reassembly function (Concatenation, segmentation and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU discard function (RLC SDU discard)
RLC re-establishment function (RLC re-establishment)

In the above description, the in-sequence delivery function of the NR RLC entity may mean a function of sequentially delivering the RLC SDUs received from the lower layer to the higher layer. When one original RLC SDU is segmented into the plurality of RLC SDUs and received, the in-sequence delivery function of the NR RLC entity may include a function of reassembling and delivering the RLC SDUs.

The in-sequence delivery function of the NR RLC entity may include a function of reordering the received RLC PDUs based on a RLC sequence number (RLC SN) or the PDCP sequence number (PDCP SN), a function of recording the lost RLC PDUs by reordering the order, a function of reporting the status of the lost RLC PDUs to the transmitting side, and a function of requesting the retransmission of the lost RLC PDUs.

The in-sequence delivery function of the NR RLC entity may include a function of delivering only the RLC SDUs before the lost RLC SDU to the higher layer in order when there is the lost RLC SDU.

The in-sequence delivery function of the NR RLC entity may include a function of delivering all the RLC SDUs received before the timer starts to the upper layer in order if a predetermined timer has expired even if there are the lost RLC SDUs.

The in-sequence delivery function of the NR RLC entity may include a function of delivering all the RLC SDUs received so far to the higher layer in order if the predetermined timer has expired even if there are the lost RLC SDUs.

The NR RLC entity may process the RLC PDUs in order in which the RLC PDUs are received, and deliver the RLC PDUs to the NR PDCP entity regardless of the order of the sequence number (out-of sequence delivery).

When the NR RLC entity receives a segment, the NR RLC entity may receive segments stored in the buffer or to be received later, reconfigure the received segments into a complete one RLC PDU, and transfer the received segments to the NR PDCP entity.

The NR RLC layer may not include the concatenation function, and perform the function in the NR MAC layer or be replaced by the multiplexing function of the NR MAC layer.

In the above description, the out-of-sequence delivery function of the NR RLC entity may mean a function of directly delivering the RLC SDUs received from the lower layer to the higher layer regardless of the order. When an original one RLC SDU is segmented into the plurality of RLC SDUs and received, the out-of-sequence delivery function of the NR RLC entity may include the function of reassembling and delivering the RLC SDUs. The out-of-sequence delivery function of the NR RLC entity may include the function of storing the RLC SN or the PDCP SN of the received RLC PDUs and ordering the order to record the lost RLC PDUs.

The NR MAC 4-15 and 4-30 may be connected to a plurality of NR RLC layer entities configured in one UE, and the main functions of NR MAC may include some of the following functions.
Mapping function (Mapping between logical channels and transport channels)
Multiplexing/demultiplexing function (Multiplexing/demultiplexing of MAC SDUs)
Scheduling information reporting function (Scheduling information reporting)
HARQ function (Error correction through HARQ)
Priority handling function between logical channels (Priority handling between logical channels of one UE)
Priority handling function between UEs (Priority handling between UEs by means of dynamic scheduling)
MBMS service identification function (MBMS service identification)
Transport format selection function (Transport format selection)
Padding function (Padding)

The NR PHY layers 4-20 and 4-25 may perform the operation of channel coding and modulating the higher layer data, converting the higher layer data into the OFDM symbols and transmitting the OFDM symbols through the wireless channel, or demodulating and channel decoding the OFDM symbols received through the wireless channel, and delivering the OFDM symbols to the higher layer.

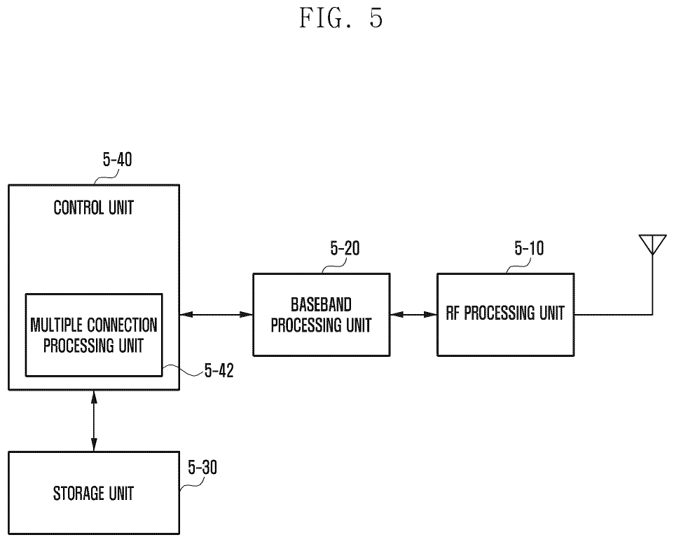

FIG. 5 is a block diagram illustrating a structure of a UE according to an embodiment of the disclosure.

Referring to FIG. 5, the UE may include a radio frequency (RF) processing unit 5-10, a baseband processing unit 5-20, a storage unit 5-30, a control unit 5-40, etc.

The RF processing unit 5-10 performs a function of transmitting and receiving signals through a wireless channel, such as band conversion and amplification of the signals. The RF processing unit 5-10 up-converts a baseband signal provided from the baseband processing unit 5-20 into an RF band signal and transmits the RF band signal through an antenna, and down-converts the RF band signal received through the antenna into the baseband signal. For example, the RF processing unit 5-10 may include a transmission filter, a reception filter, an amplifier, a mixer, an oscillator, a digital to analog converter (DAC), an analog to digital converter (ADC), etc. Referring to FIG. 5, only one antenna is illustrated, but the UE may be provided with a plurality of antennas. In addition, the RF processing unit 5-10 may include a plurality of RF chains. In addition, the RF processing unit 5-10 may perform beamforming. For the beamforming, the RF processing unit 5-10 may adjust phases and sizes of each signal transmitted and received through the plurality of antennas or antenna elements. In addition, the RF processing unit may perform MIMO and may receive a plurality of layers when performing a MIMO operation.

The baseband processing unit 5-20 performs a conversion function between a baseband signal and a bit stream according to physical layer specifications of the system. For example, when transmitting data, the baseband processing unit 5-20 encodes and modulates a transmission bit stream to generate complex symbols. In addition, when receiving data, the baseband processing unit 5-20 reconstructs a reception bit stream by demodulating and decoding the baseband signal provided from the RF processing unit 5-10. For example, in the case of following the orthogonal frequency division multiplexing (OFDM) scheme, when transmitting data, the baseband processing unit 5-20 encodes and modulates the transmission bit stream to generate the complex symbols, maps the complex symbols to subcarriers, and then configures the OFDM symbols through an inverse fast Fourier transform (IFFT) operation and a cyclic prefix (CP) insertion. In addition, when receiving data, the baseband processing unit 5-20 segments the baseband signal provided from the RF processing unit 5-10 into OFDM symbol units, reconstructs the signals mapped to the subcarriers through fast Fourier transform (FFT), and then reconstructs the reception bit stream through the demodulation and decoding.

The baseband processing unit 5-20 and the RF processing unit 5-10 transmit and receive the signals as described above. Accordingly, the baseband processing unit 5-20 and the RF processing unit 5-10 may be referred to as a transmitting unit, a receiving unit, a transmitting/receiving unit, or a communication unit. Furthermore, at least one of the baseband processing unit 5-20 and the RF processing unit 5-10 may include a plurality of communication modules to support a plurality of different radio access technologies. In addition, at least one of the baseband processing unit 5-20 and the RF processing unit 5-10 may include different communication modules to process signals of different frequency bands. For example, the different radio access technologies may include wireless LAN (e.g., Institute of Electrical and Electronics Engineers (IEEE) 802.11), cellular networks (e.g., LTE), etc. In addition, the different frequency bands may include super high frequency (SHF) (e.g., 2. NRHz, NRhz) bands, and millimeter wave (mm wave) (e.g., 60 GHz) bands.

The storage unit 5-30 stores data such as basic programs, application programs, and configuration information for the operation of the UE. In particular, the storage unit 5-30 may store information related to a second access node performing wireless communication using a second radio access technology. In addition, the storage unit 5-30 provides the stored data according to a request of the control unit 5-40.

The control unit 5-40 controls the overall operation of the UE. For example, the control unit 5-40 transmits and receives the signals through the baseband processing unit 5-20 and the RF processing unit 5-10. In addition, the control unit 5-40 records and reads data in the storage unit 5-40. For this purpose, the control unit 5-40 may include at least one processor. For example, the control unit 5-40 may include a communication processor (CP) that performs control for communication and an application processor (AP) that controls higher layers such as application programs.

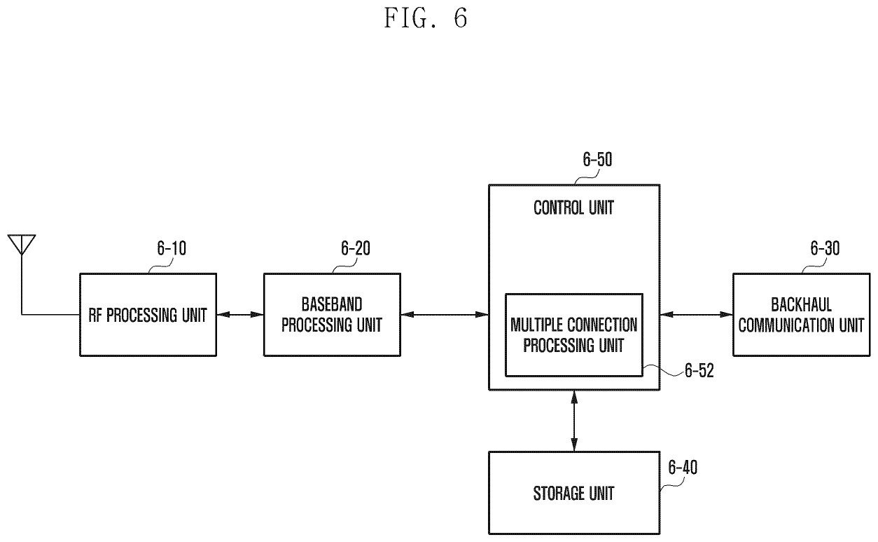

FIG. 6 is a block diagram illustrating a configuration of an NR base station according to an embodiment of the disclosure.

Referring to FIG. 6, the base station may be configured to include an RF processing unit 6-10, a baseband processing unit 6-20, a backhaul communication unit 6-30, a storage unit 6-40, a control unit 6-50, etc.

The RF processing unit 6-10 performs the function of transmitting and receiving the signals through the wireless channel, such as the band conversion and amplification of the signals. The RF processing unit 6-10 up-converts the baseband signal provided from the baseband processing unit 6-20 into the RF band signal and transmits the RF band signal through the antenna, and down-converts the RF band signal received through the antenna into the baseband signal. For example, the RF processing unit 6-10 may include a transmission filter, a reception filter, an amplifier, a mixer, an oscillator, a DAC, an ADC, etc. Referring to FIG. 6, only one antenna is illustrated, but the base station may be provided with a plurality of antennas. In addition, the RF processing unit 6-10 may include a plurality of RF chains. In addition, the RF processing unit 6-10 may perform the beamforming. For the beamforming, the RF processing unit 6-10 may adjust phases and sizes of each signal transmitted and received through the plurality of antennas or antenna elements. The RF processing unit may perform a downlink MIMO operation by transmitting one or more layers.

The baseband processing unit 6-20 performs the conversion function between the baseband signal and the bit stream according to the physical layer specifications of the first radio access technology. For example, when transmitting data, the baseband processing unit 6-20 encodes and modulates the transmission bit stream to generate the complex symbols. In addition, when receiving data, the baseband processing unit 6-20 reconstructs a reception bit stream by demodulating and decoding the baseband signal provided from the RF processing unit 6-10. For example, in the case of following the OFDM method, when transmitting data, the baseband processing unit 6-20 encodes and modulates the transmission bit stream to generate the complex symbols, maps the complex symbols to subcarriers, and then configures the OFDM symbols through the IFFT operation and the CP insertion. In addition, when receiving data, the baseband processing unit 6-20 segments the baseband signal provided from the RF processing unit 6-10 into OFDM symbol units, reconstructs the signals mapped to the subcarriers through the FFT operation, and then reconstructs the reception bit stream through the demodulation and decoding. The baseband processing unit 6-20 and the RF processing unit 6-10 transmit and receive the signals as described above. Accordingly, the baseband processing unit 6-20 and the RF processing unit 6-10 may be referred to as the transmitting unit, the receiving unit, the transmitting/receiving unit, or the wireless communication unit.

The backhaul communication unit 6-30 provides an interface for performing communication with other nodes in the network. The backhaul communication unit 6-30 converts a bit stream transmitted from the main base station to other nodes, such as an auxiliary base station and a core network, into a physical signal, and converts physical signals received from the other nodes into bit streams.

The storage unit 6-40 stores data such as basic programs, application programs, and configuration information for the operation of the main base station. In particular, the storage unit 6-40 may store information for bearers allocated to an accessed UE, a measurement result reported from the accessed UE, etc. In addition, the storage unit 6-40 may store information that serves as a decision criterion for whether to provide multiple connections to the UE or to terminate them. In addition, the storage unit 6-40 provides the stored data according to a request of the control unit 6-50.

The control unit 6-50 controls the overall operation of the base station. For example, the control unit 6-50 transmits and receives the signals through the baseband processing unit 6-20 and the RF processing unit 6-10 or through the backhaul communication unit 6-30. In addition, the control unit 6-50 records and reads data in the storage unit 6-40. For this purpose, the control unit 6-50 may include at least one processor.

Hereinafter, the following abbreviations may be used in this specification.
LTM: Layer 1/Layer 2 triggered mobility
MCG: master cell group
SCG: secondary cell group
CU: central unit
DU: distributed unit
MN: master node
SN: secondary node
C-SN: candidate SN
S-SN: serving SN

In the case of the existing Rel-18 LTM technology where inter-CU LTM is not considered, a procedure for updating a security key may not essential. However, in the case of the inter-CU LTM technology related to the case where the UE moves to a cell of a CU other than a current CU, the update of the security parameter may be essential. LTM may assume subsequent operations. Therefore, after receiving an LTM configuration once, the UE should be able to perform cell switch only by receiving a cell switch command MAC CE without being configured with additional RRC layer. Meanwhile, in relation to the disclosure, the security parameter may include the security key.

The security parameter update operation mainly considered in relation to the disclosure may be an operation in which the UE, which has received the existing sk-counter value, updates a security key value required for its SCG communication based on the received counter value (or through the counter value). In the disclosure, the security key may include S-KgNB, and may also include all other key values derived from the S-KgNB.

In particular, in the case of legacy primary SCG cell (pscell) change related to an SCG LTM, a basic sk-counter value or the security key values associated with the sk-counter value may all be generated in a master node (MN). In addition, the MN may enclose (or include) the sk-counter value in RRCReconfiguration messages that instruct (or indicate) a secondary node (SN) to change the pscell and transfer the RRCReconfiguration messages to the UE one by one. The UE updates security parameters based on the received sk-counter value while moving radio resources to a target cell, and communicates with the target cell with the updated value. In this case, the target cell may also decode or encode the data transferred from the UE using the previously transferred sk-counter values and the security key values created in association with the sk-counter value.

In the disclosure, since the SCG LTM is considered, all the necessary sk-counter values or security key values created (or generated) based on the sk-counter values are created (or generated) in the MN, and the sk-counter values or the security key values are provided to the SN or the UE that the MN requires as a basic assumption.

The methods for solving the above problems may be largely divided into the following three methods.
Opt 1. A method of preconfiguring a security key value matching an sk-counter value and using plurality of security key values as a single list when the UE moves to the target pscell on each candidate CN. A method of automatically using an sk-counter value in a next order whenever a UE performs inter CU SCG LTM, i.e., a method of preconfiguring pieces of information necessary in an RRC layer in a UE and a network.
Opt 2. When the serving DU (or source DU) indicates the cell switch through the cell switch command MAC CE, the necessary information is signaled or transmitted together, i.e., a method of immediately signaling or transmitting information necessary in the MAC layer.
Opt 3. A method of signaling or transmitting necessary information together through a DCI

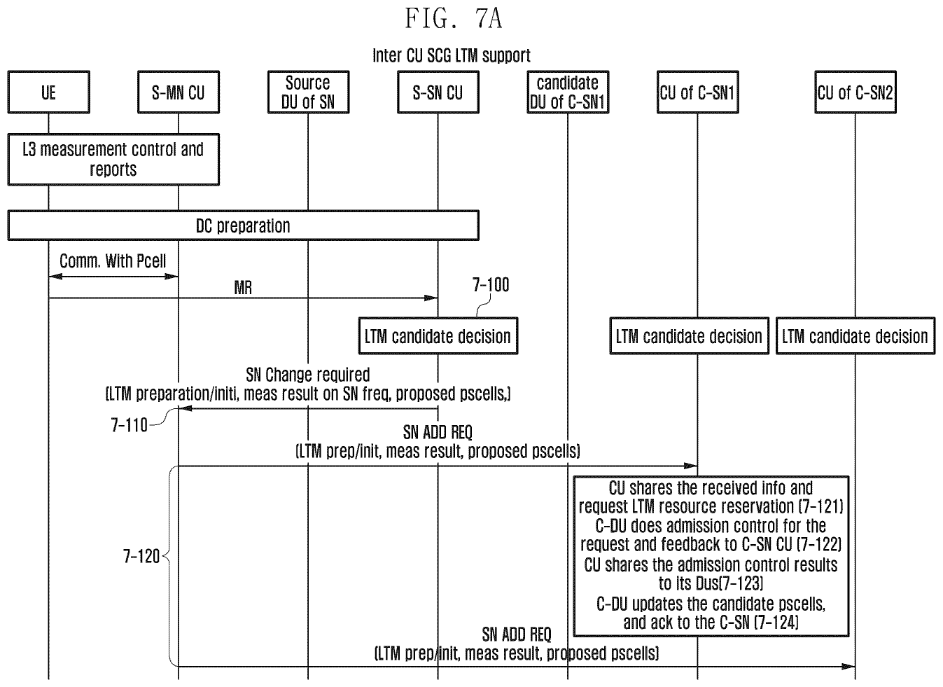

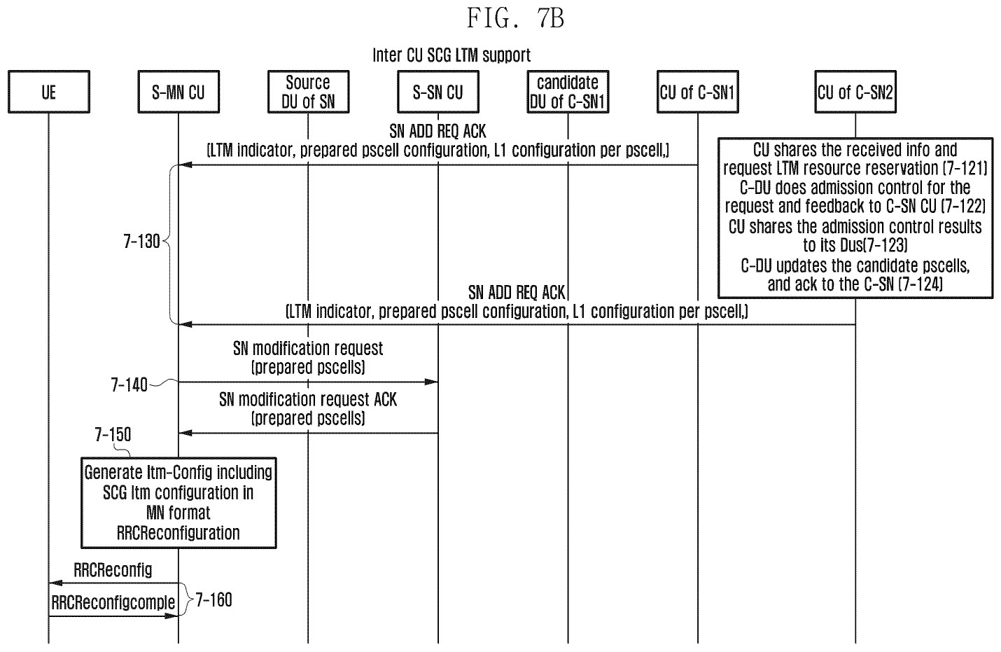

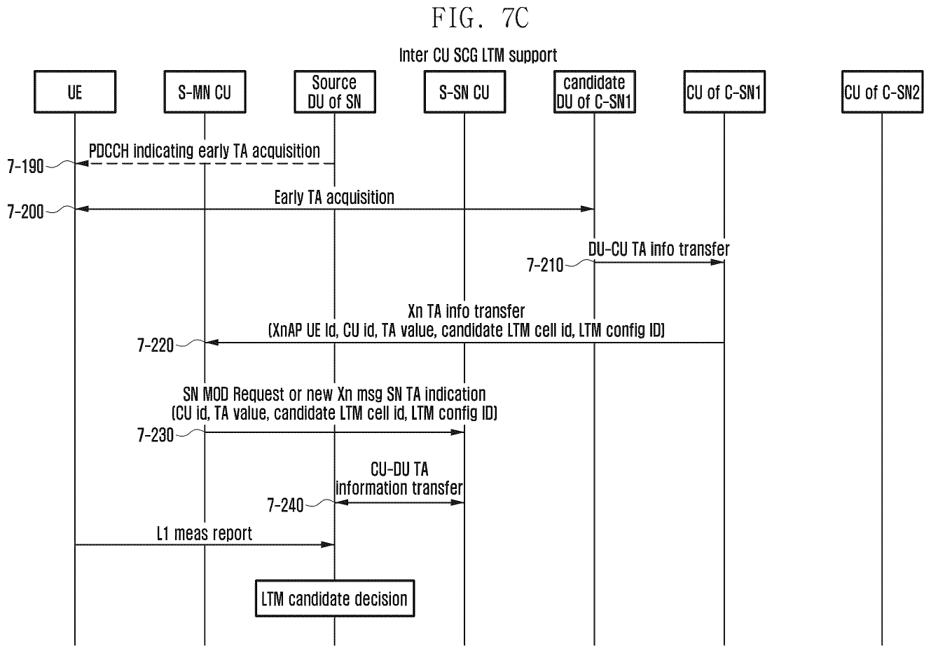

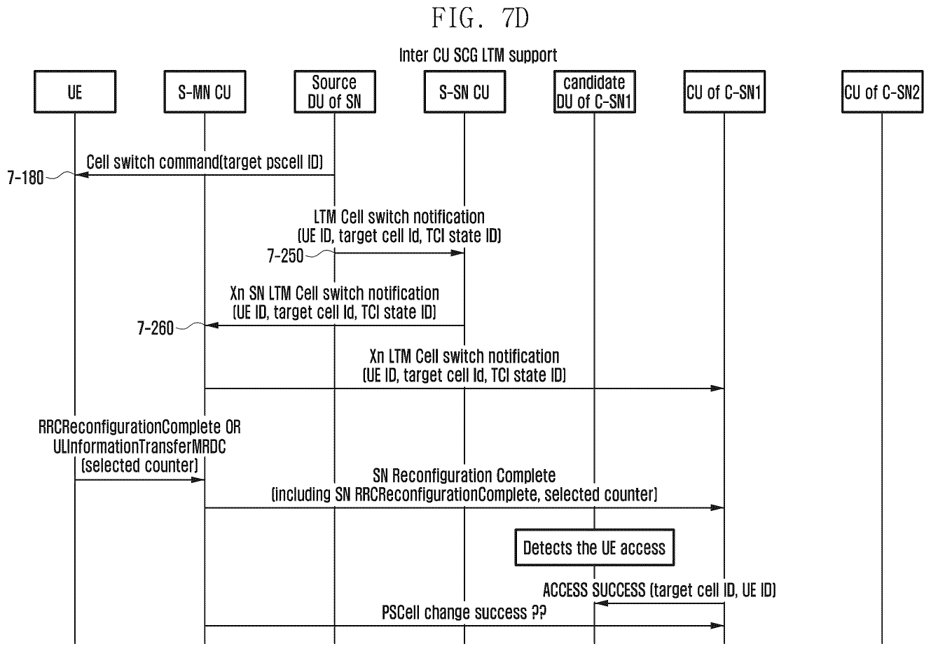

FIG. 7A to 7D are diagrams for describing an inter CU LTM operation according to various embodiments of the disclosure.

Referring to FIGS. 7A to 7D, the UE is connected to the source MN, receives a configuration for layer 3 (L3) measurement or report, and performs measurement on a frequency associated with an SN, and reports the measurement result.

Through the report, the MN may select a candidate pscell and perform the primary SCG cell (pscell) and the corresponding SCG configuration through an SN addition procedure. As a result, the UE may perform a dual connection with the network.

Thereafter, when the LTM configuration to replace a current pscell is to be configured by performing the measurement according to a configuration of a primary cell (Pcell), the source SN (S-SN) may determine an LTM candidate cell. LTM preparation may be performed.

The operations in each step of FIGS. 7A to 7D may be as follows.

1. The S-SN CU may determine candidate cell based on the corresponding measurement result (7-100) and send the information on each candidate cell to C-SNs serving each candidate cell through the MN. In this case, an SN change required message is a message that the S-SN transfers to the MN and may include the following information (7-110).
A. Indicator notifying the preparation or start of the LTM or the LTM SCG
B. Information on a radio resource measurement (RRM) measurement result of the UE in the frequency of the SN band
C. Information on a candidate pscell existing in the C-SN proposed by the S-SN
   i. Physical cell ID (PCI) and/or cell global identity (CGI) with absolute radio frequency channel number (AFRCN)
   ii. C-SN gNB ID (identifier) where each candidate cell exists
D. Channel state information (CSI) resource configuration used in cells existing in S-SN among proposed candidate cells
E. Current source DU ID
F. Physical random access channel (PRACH) resource request used in each candidate cell
G. Request for the candidate DU of C-SN to provide the lower layer configuration for the purpose of generating the reference configuration
H. Information for intra-SN LTM already configured [optional], i.e., Information for LTM candidate cells operating in S-SN that are not operated in other SNs
   i. List of candidate pscell ID confirmed/generated by S-SN
   ii. List of the mapping info between LTM config ID and corresponding candidate pscell ID (in i above) generated by S-SN
   iii. CSI resource configuration per pscell
   iv. CSI report configuration per pscell
   v. TCI (transmission configuration indicator) states configuration per pscell
   vi. RACH config of each candidate pscell
   vii. Lower layer configuration (for generating reference config at each C-SN)
I. Information for S-SN's maintained LTM candidate cells if SN maintains [optional], i.e., information for candidate cells on the inter-SN maintained by the S-SN before the preparation step of the UE
   i. List of candidate pscell ID confirmed/generated by S-SN or MN and its indicator of MN or SN
   ii. List of the mapping info between LTM config ID and corresponding candidate pscell ID generated by S-SN
   iii. CSI resource configuration per pscell
   iv. CSI report configuration per pscell
   v. TCI states configuration per pscell
   vi. RACH config of each candidate pscell
   vii. Lower layer configuration (for generating reference config at each C-SN)

2. When the MN receives the message, the MN may perform a separate SN Addition procedure for each C-SN of each proposed candidate pscell. In this case, an SN ADD request message may be used. In this message, the following information may be transferred to each C-SN (7-120).
A. Indicator indicating LTM configuration preparation or LTM initial configuration preparation: The C-SN that has received this indicator may request the LTM configuration for the given candidate pscell to the DU serving the corresponding pscell.
B. All the proposed candidate pscell in that C-SN
   i. ID of each candidate pscell (PCI or CGI with AFRCN may be used)
   ii. C-SN gNB ID where each candidate cell exists
   iii. LTM configuration ID that the MN or the S-SN allocates to each candidate cell
   iv. Request for lower layer configuration for the purpose of generating the ref config
   v. Request PRACH resource
C. All the proposed candidate pscells in the other C-SN including S-SN: This information is not admission control, but is information of other candidate pscells that DU should know when performing the subsequent LTM operation. After the SN Addition procedure, among these candidate cells, the DU may be erased, leaving only the finally admitted candidate cell.
   i. ID of each candidate pscell (PCI or CGI with AFRCN may be used)
   ii. C-SN gNB ID where each candidate cell exists
   iii. LTM configuration ID that the MN or the S-SN allocates to each candidate cell
   iv. In the case of the proposed candidate cell of the S-SN, CSI resource configuration, TCI state configuration, RACH configuration
D. Information for LTM already configured [optional] (the following information for the candidate pscells maintained by the S-SN including intra-SN and inter-SN in step 1)
   i. List of candidate pscell ID confirmed/generated by S-SN or MN and its indicator of MN or SN
   ii. List of the mapping info between LTM config ID and corresponding candidate pscell ID generated by S-SN
   iii. CSI resource configuration per pscell
   iv. CSI report configuration per pscell
   v. TCI states configuration per pscell
   vi. RACH config of each candidate pscell
   vii. Lower layer configuration (for generating reference config at each C-SN)

3. The C-SN may receive the information and transfer some or all of the received information to the C-DU operating each candidate pscell. In this case, F1 UE context modification or setup request message may be used. (7-121)
A. Current source DU ID information
B. Among the proposed candidate cells allocated to the C-SN, the candidate cells corresponding to the C-DU may be down-selected and the corresponding information may be transferred.
   i. An indicator requesting LTM resource allocation for these cells may be included
C. Candidate pscell-related information (cell ID, gNB ID, LTM config ID) allocated to DU other than the C-DU and other C-SNs
D. The following information for the remaining already confirmed LTM candidate pscells
   i. List of candidate pscell ID confirmed/generated by S-SN or MN and its indicator of MN or SN
   ii. List of the mapping info between LTM config ID and corresponding candidate pscell ID generated by S-SN
   iii. CSI resource configuration per pscell
   iv. CSI report configuration per pscell
   v. TCI states configuration per pscell
   vi. RACH config of each candidate pscell
   vii. Lower layer configuration (for generating reference config at each C-SN)

4. The C-DUs that receive the information may perform the following operations through the received information and transfer the related information to the C-SN. In this case, an F1 UE context set/modification response message may be used. (7-122).
A. LTM resource allocation for proposed candidate pscells may be determined.
   i. In the case of each admitted candidate cell, the following information may be transmitted to the C-SN
      Cell ID and/or linked LTM configuration ID
      TCI state configuration
      RACH configuration
      CSI resource configuration
      CSI report Configuration: This is determined by referring to the information of all other LTM candidate cells below.
      Generated lower layer configuration if requested,
B. cell ID, mapping of cell and LTM configuration ID of all candidate pscells received from the MN may be stored.
C. The following information for all the already confirmed LTM candidate cells is stored and used when performing the subsequent LTM.
   i. List of candidate pscell ID confirmed/generated by S-SN or MN and its indicator of MN or SN
   ii. List of the mapping info between LTM config ID and corresponding candidate pscell ID generated by S-SN
   iii. CSI resource configuration per pscell,
   iv. CSI report configuration per pscell
   v. TCI states configuration per pscell
   vi. RACH config of each candidate pscell
   vii. Lower layer configuration (for generating reference config at each C-SN)

5. The C-SN that has received the information may share admitted candidate cell-related information with other C-DUs in the C-SN. In this way, LTM subsequent may be performed between newly confirmed candidate cells in this LTM preparation within the C-SN (7-123).

6. Each C-DU that has received the information may update the CSI report configuration of the candidate cells that the C-DUs operate by newly adding the CSI resource configuration of the newly confirmed candidate cells. Each C-DU may transfer the CSI report configuration of each of the newly updated candidate cell to the C-SN. In addition, each C-DU may transfer the updated lower layer configuration (7-124).

7. Each C-SN may transfer the following information to the MN. In this case, as the message, an SN ADD REQ ACK message may be used (7-130).
A. PCI and/or LTM candidate configuration ID of the admitted candidate pscell
B. As information of each admitted candidate pscell
   i. As target pscell configuration information including updated lower layer information, RRCReconfiguration message
   ii. Indicator of whether the message is a complete message or not
   iii. CSI resource configuration
   iv. CSI report configuration
   v. RACH configuration
   vi. TCI state configuration
C. The allocated resources of the accepted pscells may be kept until separate release indication or cancel indication is received from the MN or other SNs.
D. A reference configuration of this C-SN may be created and transmitted. The gNB ID of the C-SN may be associated with (or mapped to) the reference configuration.

8. The MN receives the information, and identifies (or indicates) to reuse the LTM configuration ID, which has been previously allocated to not admitted candidate cells, later. Also, the MN may store the received pieces of information.
A. The MN may transfer the information for the finally admitted candidate cells in C-SNs other than its C-SN to all other C-SNs, including the S-SN. This information may be as follows. The message used at this time may be an Xn SN Modification request message (7-140).
   i. PCI and/or LTM candidate config ID of the admitted or not admitted candidate cell
   ii. CSI resource configuration of other C-SNs including admitted candidate cell
   iii. Updated CSI report configuration and TCI state config, RACH config of candidate cells of each C-SN
B. Although not illustrated in the drawings, the C-SN that has received the information may transfer the corresponding pieces of information to its C-DU again to update the necessary information.
C. The pieces of information should be transferred even if all the proposed candidate cells are admitted.
D. After transferring the information to each SN, the MN may configure an ltm-configuration using pieces of information including but not limited to a target cell configuration of each candidate cell, and may transfer the ltm-configuration to the UE by including the ltm-configuration in an Itm-Config field of an RRCReconfiguration message. The Itm-config field may include the following information (7-150).
   i. Of each candidate cell
      LTM candidate ID
      PCI
      SSB config
      Candidate config with reference ID below
      Complete config indicator
      DL TCI state info
      Using early TA (timing advance) indicator
      RACH-less execution indicator
   ii. LTM reference List
      Each reference config per C-SN having SN related ID
E. When the MN transfers the ltm-config to UE, the MN may transfer the ltm-config by including the ltm-config in RRCReconfiguration of an MN format. In this case, the ltm-config may be transferred using signaling radio bearer 1 (SRB1).
   i. In particular, the candidate config in the ltm-config may include the RRCReconfiguration created by each C-SN as the SCG configuration and mean the RRCReconfiguration to which an MCG configuration corresponding to the SCG configuration is added.
   ii. When the UE is indicated with the switch through inter-CU cell switch command MAC CE and is successfully accessed, the UE may notify MN through an RRCReconfigurationComplete or ULInformationTransferMRDC message through the SRB1 of the MN. In this case, an SN RRCReconfigurationComplete message may be encapsulated in RRCReconfigurationComplete/ULInformationTransferMRDC.

9. When the UE receives the MN format RRC Reconfiguration message, the UE may store the corresponding pieces of ltm-config information in UE variable (7-160). In addition, if a specific LTM candidate ID is indicated through the cell switch command MAC CE in the serving cell (7-180), movement to the corresponding pscell may be performed by applying the corresponding candidate configuration. In this case, when an early TA indicator is indicated (7-190), the UE may transmit a preset RACH preamble to the LTM candidate cell associated with the corresponding indicator (7-200). Accordingly, the target C-DU may measure the corresponding preamble to estimate a TA value (7-200), and when the target C-DU notifies the C-SN of this value with the DU-CU TA info transfer message (7-210), the C-SN may notify the MN of the corresponding information again. In this case, a new Xn message or an Xn TA info transfer message may be used (7-220). This message may include at least one of the following pieces of information.
A. XnAP UE ID, Rach preamble index, C-SN ID, TA value, PCI of the corresponding candidate cell, LTM candidate config ID of the corresponding candidate cell
B. The MN that has received the information should notify the current S-SN of the information again. In this case, a new Xn message or an SN MOD request message may also be used, and the information that may be included at this time is as follows (7-230).
   i. C-SN id or corresponding gNB CU ID, TA value, candidate LTM cell ID, LTM config ID
C. The S-SN that has received the information may notify its S-DU of the TA value (7-240).

10. When the S-DU indicates a cell switch command to any candidate cell in the S-DU, the S-DU may simultaneously notify it to the S-SN by transmitting an LTM cell switch notification (7-250). This may be to prevent the S-SN from additionally instructing an L3 pscell change. In addition, a potential target DU that has received this message may determine whether the UE performs access or completes access through the enclosed TCI state information after receiving this message. For a similar operation, the S-SN that has received the indication intends to give the same indication to the C-DU of the target pscell through the MN. Accordingly, the S-SN may notify the C-SN of the target pscell using the Xn SN Cell switch notification message or the corresponding Xn message transferred to MN (7-260). This message may include a UE ID (Xn AP UE ID, or the corresponding GUPI, SUPI), a target cell ID (LTM candidate ID or PCI, or CGI with AFRCN), a TCI state ID, etc., that are indicated to switch the cell.

11. The MN that received this information may also notify the C-SN of the target pscell of the received information using the Xn LTM Cell switch notification message or the corresponding Xn uni directional message (7-270). Similar to the message, this message may include the UE ID, the target cell ID, or the TCI state ID. The C-SN that has received the message notifies the DU operating the corresponding target cell of the contents. Based on this, the target C-DU may detect the access of the UE and determine the success or failure of the access.

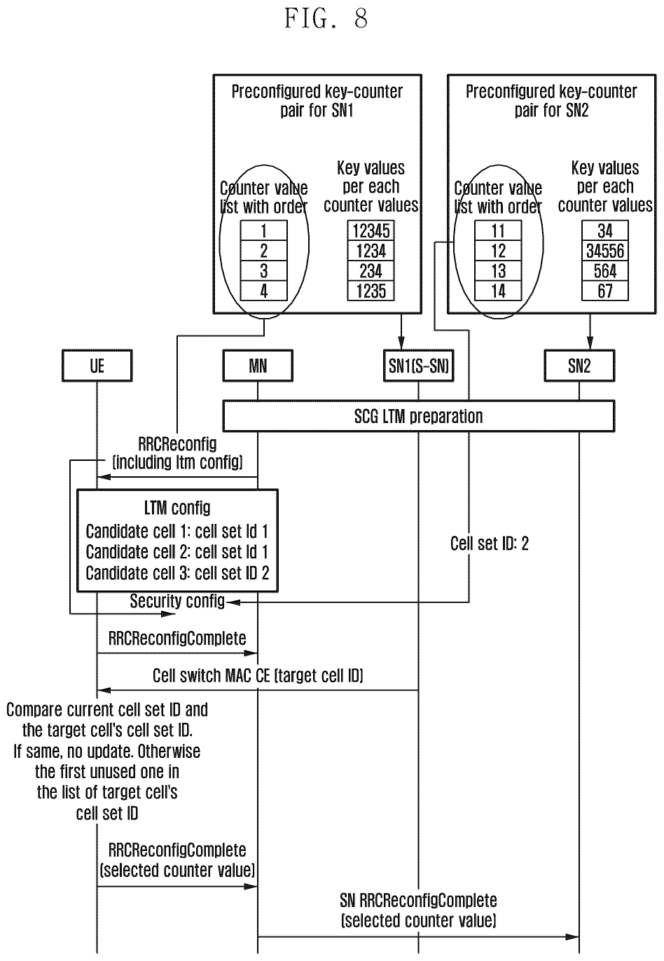

FIG. 8 is a diagram for describing entire opt 1 according to an embodiment of the disclosure.

Referring to FIG. 8, the UE may be in a connected state with the MN. In addition, the MN may write (or generate) the following information in the SCG LTM preparation process and transfer the following created information in advance to the C-SNs including each S-SN.
Pair of the sk-counter value used for the SCG configuration of UE and the security key value applied with the sk-counter value (or corresponding to the sk-counter value).

### A List of the Pairs

### The List of the Pairs Can Be Allocated to One SN

Referring to FIG. 8, the information may be transferred to each S-SN and C-SN in the SCG LTM preparation process (or step).

Thereafter, the MN may transfer to the UE a list of only counter values from the counter-key pair list allocated to each SN and an ID value (e.g., cell set ID) indicating the SN to which the list is allocated by associating (or mapping) the list of only counter values with the ID value. In addition, the list of only the counter values may maintain its original order of the counter-key list when it is initially allocated to each SN. In the process, the cell set ID allocated to the SN of the current pscell may be transferred by being enclosed (or included) into a servingCellSetID field. In this case, the UE may store the ID value in a variable.

Additionally, when the MN transfers the configuration of the SCG LTM to the UE, the configuration of each candidate target pscell and the ID value (cell set ID) indicating the SN of the corresponding pscell may be transferred by being associated with each other. That is, the LTM configuration ID of candidate pscell 1+the cell set ID indicating the SN of the corresponding pscell may be transferred by being associated with (or mapped to) each other.

The UE that has received the information may be in a state in which the preparation for performing the SCG LTM is completed.

Thereafter, when the serving DU transfers the target pscell ID, i.e., the LTM configuration ID corresponding to the target pscell or PCI or NR cell global identity (NCGI) of the target pscell through the cell switch MAC CE, the UE may identify the cell set ID corresponding to (or equivalent to) the corresponding target pscell ID and compare the cell set ID with the cell set ID currently stored in the variable.

When the cell set ID is the same as the cell set ID currently stored in the variable, the existing counter value may be used as it is and the security key update may not be performed. However, if the cell set ID is different from the cell set ID currently stored in the variable, the UE may update the cell set ID stored in the variable to a cell set ID value of a new target cell, and also apply a first value (or a value at the top) in the counter list information associated with (or mapped to) the corresponding cell set ID as a new sk-counter value. In addition, the update of the security key to which the new sk-counter value is applied may be performed. Additionally, the previously used counter value may be removed from the list.

When the update of the counter value is performed and the target cell configuration is successfully applied, the UE may indicate the MN to complete the pscell change operation through RRCReconfigurationComplete or the corresponding RRC message. This message may be transferred by including a newly selected counter value. The new counter value may be transferred from the MN to the SN of the target pscell through an SN RRCReconfiguration complete message. Through this value (the new counter value), the SN of the target pscell recognizes the counter value to be used when communicating with the UE and the security key value associated therewith, and may perform secured communication with the UE without a separate signal when the UE attempts to access in a wireless section.

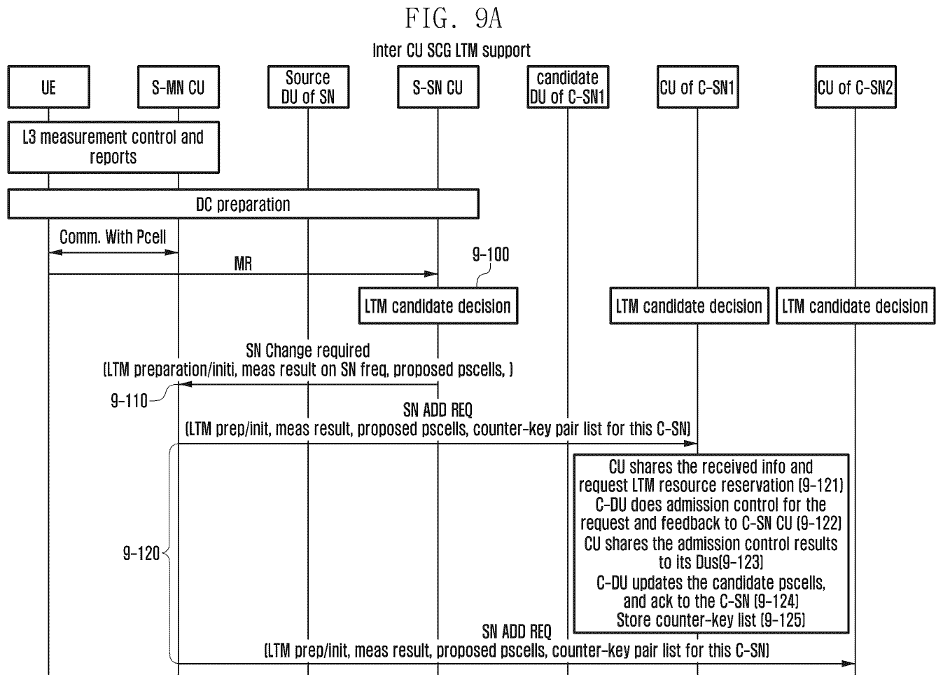

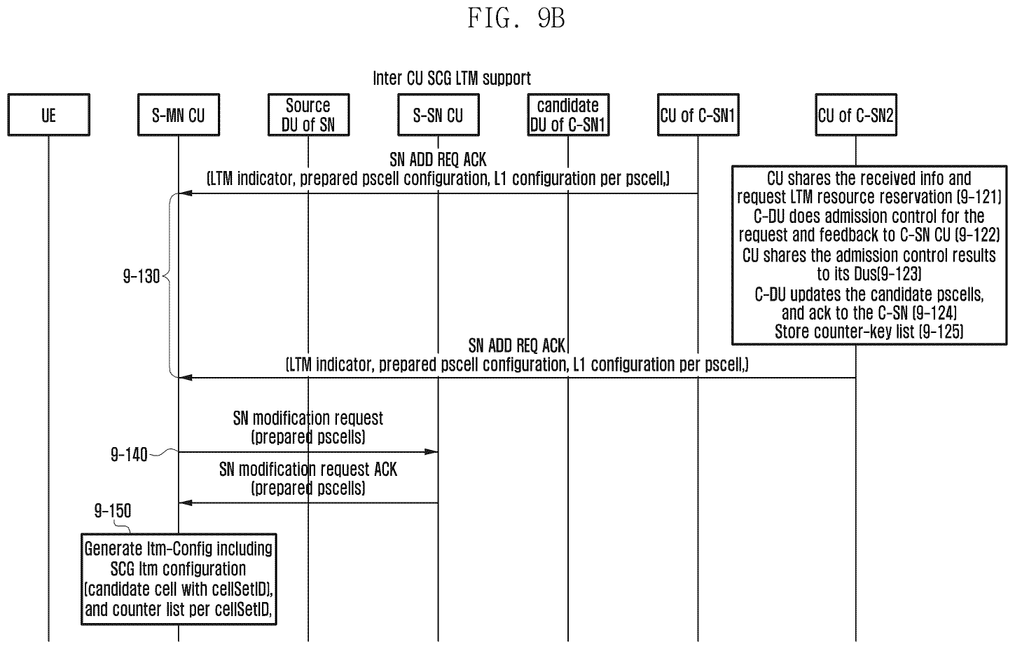

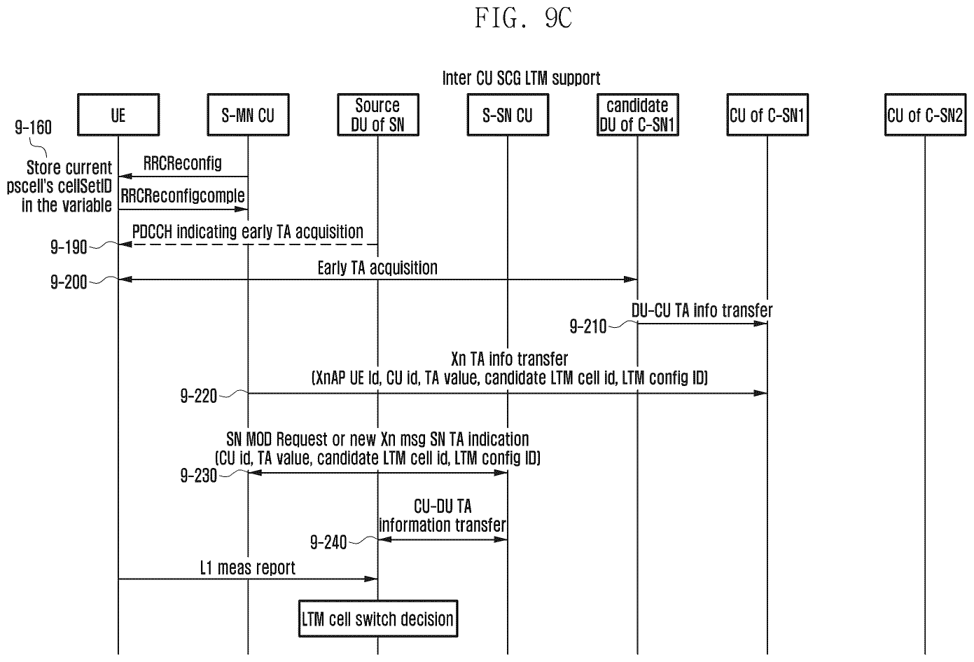

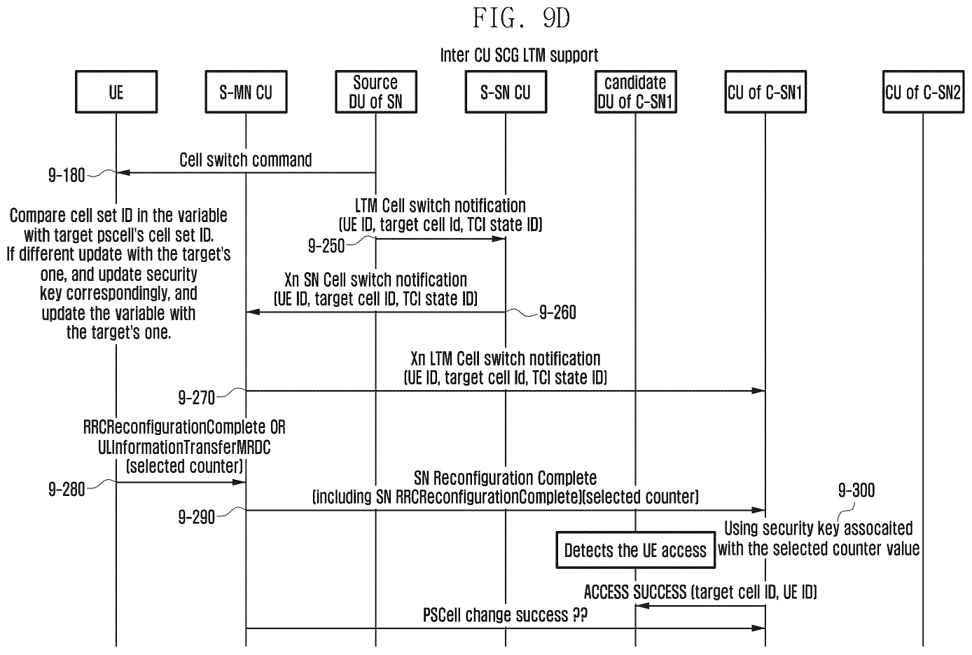

FIGS. 9A to 9D are diagrams for describing opt 1 in relation to an inter CU SCG LTM signal transmission process according to various embodiments of the disclosure.

Specifically, FIGS. 9A to 9D may be descriptions of the operation of FIG. 8 by substituting (or based on) the actual inter CU SCG LTM signal transmission process. FIGS. 9A to 9D are diagrams in which some steps or operations in FIGS. 7A to 7D are added, and the step-by-step operation of FIGS. 9A to 9D may correspond to the same (or similar) steps of FIGS. 7A to 7D. Therefore, the description of common steps or operations of FIGS. 9A to 9D and 7A to 7D may be omitted below, and the description of the omitted steps or operations may refer to the description of FIGS. 7A to 7D. The description below may focus on added contents in relation to the opt 1 operation, compared to the description of FIGS. 7A to 7D.

In step 9-120, the MN transfers to each C-SN a mapping list of the counter values to be used in the UE and the corresponding security key values when moving to the candidate cell of the corresponding C-SN.

In step 9-125, the C-SN that has received the information from the MN may store the corresponding information.

In step 9-150, the MN that has acquired the admitted candidate pscell information from each C-SN may transfer the Itm configuration to the UE in consideration of only the C-SNs that operate the corresponding admitted pscell. In this case, the ltm configuration is security-related information and may include at least one of the following pieces of information.
sk-counter value list (including information on sequence) associated with the ID (securityCellSetID) allocated to each C-SN
SecurityCellSetID values for each LTM candidate cell
ID (servingSecurityCellSetID) allocated to the SN of the current pscell.

In step 9-160, the UE may store the information received from the MN.

In step 9-180, when the source DU indicates the cell switch, the target pscell ID (or target LTM candidate ID) included in the corresponding the cell switch command MAC CE may be identified to determine whether the corresponding ID indicates the cell switch to the LTM candidate cell indicated by the corresponding ID. When the corresponding ID indicates the cell switch to the stored LTM candidate cell, the securityCellSetID of the stored candidate cell may be compared with the currently stored servingSecurityCellSet ID value. In this case, when the two values are the same, a separate security key update may not be performed, and when the two values are different, the security Cell Set ID of the stored candidate cell may be updated to servingSecurityCellSetID, and the value may be stored. In addition, the first value (or the value at the top) in the counter value list with which the securityCellSetID of the target pscell is associated (or mapped) may be selected as the sk-counter value, and the security key update may be performed based on the value.

In step 9-280, when the UE successfully performs the cell switch, the UE may notify the MN of the cell switch completion through the RRCReconfigurationComplete message or the ULInformationTransferMRDC or the corresponding UL RRC message. In this case, the UE may transfer the counter value finally selected in the UL RRC message to the MN.

In step 9-290, the MN may transfer the selected counter value to the C-SN of the target pscell. The C-SN that has received the selected counter value may identify the received counter value based on the counter-key mapping list received in step 9-120, and use the key value mapped to the counter value as the security key used to perform communication with the UE.

The following may be a detailed description of the opt 2. In the case of the opt 2, the update of the security parameter may be performed at a network side. That is, the MN may create (or generate) a list of security parameters (e.g., counter value, corresponding security key value, IDs referring to each counter, IDs corresponding to each security key, or an ID referring to the counter-security key pair) corresponding to each C-SN and transfer the created list to each C-SN. The pieces of information may be transferred by matching the ID or information referring to the C-SN. In this case, the security parameters transferred to all SNs and their DUs should maintain the same order, and may need to keep in synchronization with what security parameters the UE is currently using.

Each C-SN that has received the information may transfer all of the information to their DU.

Using the information, when each DU becomes a source DU and determines to proceed with the SCG LTM, each DU may determine the target pscell, and when the corresponding pscell is the inter-CU LTM, each DU may directly signal (or transfer) the security information associated with the target pscell to the UE. The signaling method used at this time may be the cell switch command MAC CE. That is, the cell switch command MAC CE may include an ID referring to the target pscell to be moved to or an LTM configuration ID referring to the corresponding target cell, a TCI state ID as beam information to be used when moving (or moving), and a security parameter to be used in the corresponding cell.

The security parameters for each option may be as follows.
Opt 1. sk-counter value
Opt 2. K_SN
Opt 3. Index which indicates one of sk-counter value given to the UE a priority

In the case of the Opts 1 and 2, a separate operation may not be required to perform the security key update from the UE perspective. That is, whenever the UE performs the cell switch command, the UE may update a new security key by applying the enclosed and received counter value, or may operate by applying the received K_SN (i.e., security key) as it is. However, there may be a risk when directly transferring security information on an air interface.

In the case of Opt 3, instead of the sk-counter value, an index or ID indicating the corresponding value may be signaled (or transmitted). In this case, there is an advantage in that the amount of information signaled or transmitted is smaller than in the existing opts 1 and 2, and the information that may be leaked on the air interface in the middle is not a direct security-related value. Instead, the network should transfer to the UE the list information of the index and the counter value mapped to the index before the cell switch command. These pieces of information may be transferred by being enclosed in the RRCReconfiguration message that transfers the LTM configuration.

In the cases of the opts 1, 2, and 3, when there is no separate security parameter information in the cell switch command, the UE may use the previously used counter and key value as they are.

In the cases of the opts 1, 2, and 3, the DUs of the CUs that manage all the LTM candidate cells should store the counter value, the Key (K_SN), and the index-related values associated with all the candidate cells. Accordingly, if necessary, the cell switch command may be transmitted to the UE by adding (or including) the necessary security parameters.

When the cell switch command is given (or in response to the cell switch command) and thus the UE successfully moves to the target cell, the success of the LTM cell switch for each C-SN should be transferred from the target DU to all the C-SNs through the CU of the corresponding target DU. Each C-SN should transfer and notify the information to all of their DUs. The information transferred at this time may include the target cell ID, the LTM configuration ID of the target pscell, or the ID of the UE. The DUs that have received the notification may know the security parameter values of the current UE (or that the current UE uses), and may determine based on the security parameter value whether to transfer a new security parameter value or not when the DUs issue the cell switch command to the UE later.

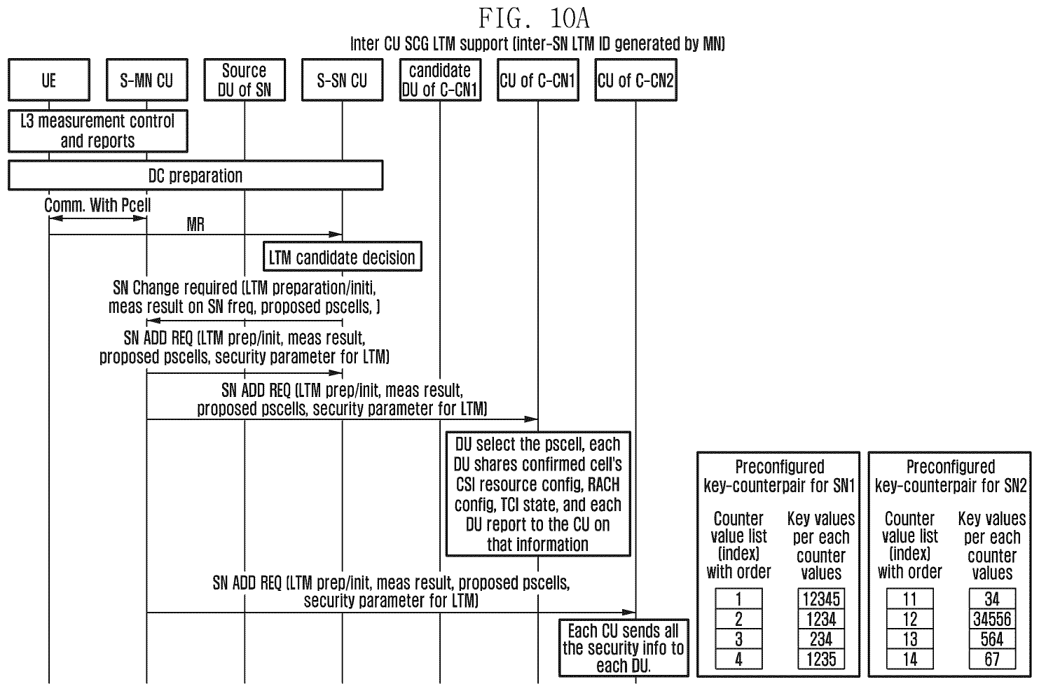

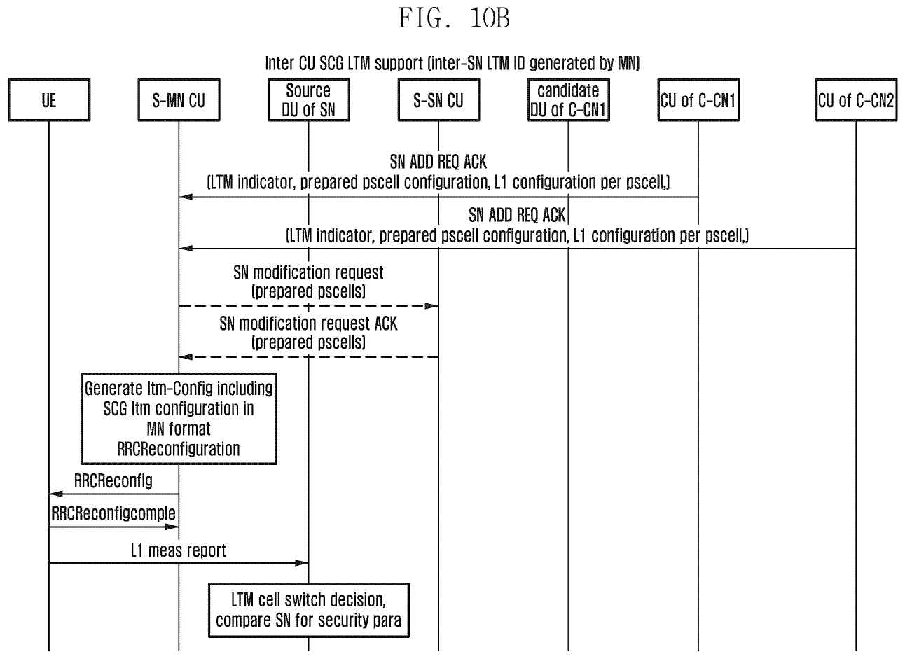

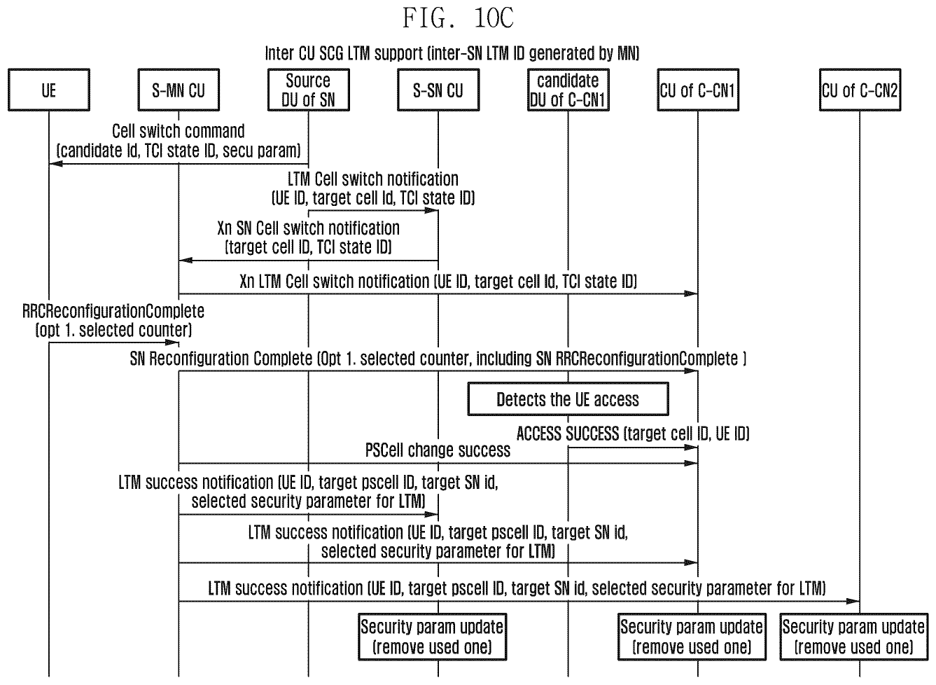

FIGS. 10A to 10C are diagrams for describing opt 2 in relation to an inter CU SCG LTM signal transmission process according to various embodiments of the disclosure.

FIGS. 10A to 10C may be diagrams illustrating a case in which the cell switch command is performed by including the security parameter in the MAC CE, and may be a diagram of an inter CU SCG LTM signaling system related to the opt 2. FIGS. 10A to 10C are diagrams in which some steps or operations in FIGS. 7A to 7D are added, and the step-by-step operation of FIGS. 10A to 10C may correspond to the same (or similar) steps of FIGS. 7A to 7D. Therefore, the description of common steps or operations of FIGS. 10A to 10C and 7A to 7D may be omitted below, and the description of the omitted steps or operations may refer to the description of FIGS. 7A to 7D. The description below may focus on added contents in relation to the opt 2 operation, compared to the description of FIGS. 7A to 7D.

The UE may be in a connected state with the source MN (S-MN). Thereafter, the pscell of the S-SN may be added to configure the dual connection in the UE.

In the DC configuration step or the step after the DC configuration, a process of transferring the security parameter sets created by the MN to the C-SNs including the S-SN may be required. In FIGS. 10A to 10C, it is assumed that the information (the security parameter set created by the MN) of the MN is transferred after the DC is configured and the S-SN determines to perform the SCG LTM. Referring to FIGS. 10A to 10C, after the S-SN determines to perform the SCG LTM, the information on the SCG LTM candidate cells may be transferred to the MN through an SN change required message. The MN may identify the candidate SN, i.e., the C-SN, for each candidate cell and transfer a message (e.g., an SN ADD REQ message) requesting resource allocation for performing the SCG LTM for the candidate cells to each C-SN. In this case, the pieces of security parameter pair information created by the MN may be transferred along with the message.

The SNs that have received the security parameter pair information created by the MN transfer the information to their DUs again. In this case, a message such as F1 UE context setup/modification may be used.

Each C-SN may determine the resource allocation for the candidate pscells and notify the MN of the related information such as the information of the candidate pscells finally determined to be allocated. In this case, the SN ADD REQ ACK message may be used. Meanwhile, the security-related information may not be included separately.

The MN may transfer the LTM configuration to the UE using the information on the determined candidate cells.

Thereafter, the source DU of the S-SN may indicate the UE to perform the L1 measurement or the reporting procedure, receive the results, and determine the cell switch to one of the candidate cells of the SCG LTM. In this case, the cell switch command MAC CE including the security value (or including the value), etc., corresponding to the target pscell may be signaled (or transmitted) to the UE based on the information related to the security parameters received from the MN in the previous step.

The UE may perform the security update by applying the transferred security parameters. Thereafter, the RRCReconfigurationComplete message or the ULInformationTransferMRDC message may be used to notify the MN of the successful performance of the pscell change. In this case, the additionally selected sk-counter value may be included. When the pscell change succeeds, the CU of the target pscell may notify the MN of the fact that the pscell change succeeds through a PSCell change success message. The MN may receive the message and transmit an LTM success notification message to all the SNs (including S-SN). (Or, the corresponding Xn message may be used to notify that the LTM performance of the UE succeeds.) The message may include at least one of the UE ID, the target pscell ID, the related LTM configuration ID, the ID of the SN of the target pscell in which the cell switch succeeds, or the selected security parameter.

When the message is transferred to each C-SN, each SN transfers the corresponding (or related) information to its C-DUs so that all the C-DUs may know to which target PScell or SN the current UE moves. In addition, each SN may remove the security parameter used before the UE moves from the related list. Later, when the source DU selects a first (unused) parameter in the parameter list mapped to each SN ID as the security parameter and instructs (or command) the cell switch to the terminal, the selected security parameter may be included in the cell switch instruction (or command) to the terminal.

Methods according to the embodiments described in the claims or specifications of the disclosure may be implemented in the form of hardware, software, or a combination of hardware and software.

When implemented in software, a computer-readable storage medium storing one or more programs (software modules) may be provided. One or more programs stored in the computer-readable storage medium are configured to be executable by one or more processors in an electronic device. One or more programs include instructions for causing an electronic device to execute methods according to embodiments described in the claim or specifications of the disclosure.

Such programs (software modules, software) may be stored in random access memory, non-volatile memory including flash memory, read only memory (ROM), electrically erasable programmable read only memory (EEPROM), magnetic disc storage device, a compact disc-ROM (CD-ROM), digital versatile Discs (DVDs), any other form of optical storage device, and a magnetic cassette. Alternatively, it may be stored in memory composed of a combination of some or all thereof. In addition, each configuration memory may be included in plurality.

In addition, the program may be stored in an attachable storage device that may accessed through a communication network such as the Internet, the Intranet, a local area network (LAN), wide LAN (WLAN), or a storage area network (SAN), or a combination thereof. Such a storage device may be connected to a device implementing an embodiment of the disclosure through an external port. In addition, a separate storage device on the communication network may be connected to the device implementing the embodiment of the disclosure.

In the specific embodiments of the disclosure described above, components included in the disclosure are expressed in the singular or plural according to the specific embodiments presented. However, the singular or plural expression is appropriately selected for the context presented for convenience of description, and the disclosure is not limited to the singular or plural components, and even if the component is expressed in plural, the component is configured in singular or even if the component is expressed in singular, the element may be configured in plural.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a master node (MN), first information on a layer 1/layer 2 triggered mobility (LTM) configuration for candidate primary secondary cells (PSCells) and second information on a mapping between a counter value list and a cell set identification (ID), wherein an LTM configuration ID for a candidate PSCell is associated with the cell set ID of the candidate PSCell;
receiving, from the MN, a medium access control (MAC) control element (CE) for an LTM cell switch, the MAC CE including third information indicating the LTM configuration ID for the candidate PSCell;
identifying whether the cell set ID of the candidate PSCell corresponds to a serving cell set ID, based on the first information and the third information;
in case that the cell set ID of the candidate PSCell does not correspond to the serving cell set ID, updating a counter value for the serving cell set ID to a counter value for the cell set ID of the candidate PSCell based on the second information; and
transmitting, to a candidate secondary node (SN) of the candidate PSCell via the MN, the counter value for the cell set ID of the candidate PSCell.

2. The method of claim 1, wherein the counter value for the cell set ID of the candidate PSCell is used for generating the a security key for the candidate SN.

3. The method of claim 1, wherein the counter value for the cell set ID of the candidate PSCell is a first value in a counter value list mapped to the cell set ID of the candidate PSCell.

4. The method of claim 1, further comprising:
updating the serving cell set ID to the cell set ID of the candidate PSCell;
storing the cell set ID of the candidate PSCell; and
deleting the counter value for the serving cell set ID from a counter value list mapped with the serving cell set ID.

5. The method of claim 1, further comprising:
in case that the cell set ID of the candidate PSCell corresponds to the serving cell set ID, maintaining the counter value for the serving cell set ID.

6. A method performed by a master node (MN) in a wireless communication system, the method comprising:
transmitting, to a terminal, first information on a layer 1/layer 2 triggered mobility (LTM) configuration for candidate primary secondary cells (PSCells) and second information on a mapping between a counter value list and a cell set identification (ID), wherein an LTM configuration ID for a candidate PSCell is associated with the cell set ID of the candidate PSCell;
transmitting, to the terminal, a medium access control (MAC) control element (CE) for an LTM cell switch, the MAC CE including third information indicating the LTM configuration ID for the candidate PSCell;
in case that the cell set ID of the candidate PSCell does not correspond to a serving cell set ID, receiving, from the terminal, a counter value for the cell set ID of the candidate PSCell, wherein the serving cell set ID is associated with a PSCell of a secondary node (SN), and wherein the SN is connected with the terminal for a dual connectivity (DC); and
transmitting, to a candidate SN of the candidate PSCell, the counter value for the cell set ID of the candidate PSCell.

7. The method of claim 6, further comprising:
transmitting, to the candidate SN, fourth information on a mapping between the counter value list and a list of a security key,
wherein the counter value for the cell set ID of the candidate PSCell is used for generating the a security key for the candidate SN.

8. The method of claim 6, wherein the counter value for the cell set ID of the candidate PSCell is a first value in a counter value list mapped to the cell set ID of the candidate PSCell.

9. The method of claim 6, wherein the counter value for the serving cell set ID is deleted from a counter value list mapped with the serving cell set ID.

10. The method of claim 6, wherein in case that the cell set ID of the candidate PSCell corresponds to the serving cell set ID, a counter value for the serving cell set ID is maintained.

11. A terminal in a wireless communication system, the terminal comprising:
a transceiver; and
a processor coupled with the transceiver and configured to:
receive, from a master node (MN), first information on a layer 1/layer 2 triggered mobility (LTM) configuration for candidate primary secondary cells (PSCells) and second information on a mapping between a counter value list and a cell set identification (ID), wherein an LTM configuration ID for a candidate PSCell is associated with the cell set ID of the candidate PSCell,
receive, from the MN, a medium access control (MAC) control element (CE) for an LTM cell switch, the MAC CE including third information indicating the LTM configuration ID for the candidate PSCell,
identify whether the cell set ID of the candidate PSCell corresponds to a serving cell set ID, based on the first information and the third information,
in case that the cell set ID of the candidate PSCell does not correspond to the serving cell set ID, update a counter value for the serving cell set ID to a counter value for the cell set ID of the candidate PSCell based on the second information, and
transmit, to a candidate secondary node (SN) of the candidate PSCell via the MN, the counter value for the cell set ID of the candidate PSCell.

12. The terminal of claim 11, wherein the counter value for the cell set ID of the candidate PSCell is used for generating the a security key for the candidate SN.

13. The terminal of claim 11, wherein the counter value for the cell set ID of the candidate PSCell is a first value in a counter value list mapped to the cell set ID of the candidate PSCell.

14. The terminal of claim 11, wherein the processor is further configured to:
update the serving cell set ID to the cell set ID of the candidate PSCell,
store the cell set ID of the candidate PSCell, and
delete the counter value for the serving cell set ID from a counter value list mapped with the serving cell set ID.

15. The terminal of claim 11, wherein the processor is further configured to maintain the counter value for the serving cell set ID, in case that the cell set ID of the candidate PSCell corresponds to the serving cell set ID.

16. A master node (MN) in a wireless communication system, the MN comprising:
a transceiver; and
a processor coupled with the transceiver and configured to:
transmit, to a terminal, first information on a layer 1/layer 2 triggered mobility (LTM) configuration for candidate primary secondary cells (PSCells) and second information on a mapping between a counter value list and a cell set identification (ID), wherein an LTM configuration ID for a candidate PSCell is associated with the cell set ID of the candidate PSCell,
transmit, to the terminal, a medium access control (MAC) control element (CE) for an LTM cell switch, the MAC CE including third information indicating the LTM configuration ID for the candidate PSCell,
in case that the cell set ID of the candidate PSCell does not correspond to a serving cell set ID, receive, from the terminal, a counter value for the cell set ID of the candidate PSCell, wherein the serving cell set ID is associated with a PSCell of a secondary node (SN), and wherein the SN is connected with the terminal for a dual connectivity (DC), and
transmit, to a candidate SN of the candidate PSCell, the counter value for the cell set ID of the candidate PSCell.

17. The MN of claim 16,
wherein the processor is further configured to transmit, to the candidate SN, fourth information on a mapping between the counter value list and a list of a security key, and
wherein the counter value for the cell set ID of the candidate PSCell is used for generating the a security key for the candidate SN of the candidate PSCell.

18. The MN of claim 16, wherein the counter value for the cell set ID of the candidate PSCell is a first value in a counter value list mapped to the cell set ID of the candidate PSCell.

19. The MN of claim 16, wherein the counter value for the serving cell set ID is deleted from a counter value list mapped with the serving cell set ID.

20. The MN of claim 16, wherein in case that the cell set ID of the candidate PSCell corresponds to the serving cell set ID, a counter value for the serving cell set ID is maintained.
